(19) United States
(12) Patent Application Publication
(10) Pub. No.: US 2017/0119044 A1
(43) Pub. Date: May 4, 2017

(54) VAPORIZER CASE

(71) Applicant: HYDRA VAPOR TECH, LLC, Kansas City, MO (US)

(72) Inventors: Eric OLIGSCHLAEGER, Fairway, KS (US); Nathan Cobb, Shawnee, KS (US)

(21) Appl. No.: 15/342,622

(22) Filed: Nov. 3, 2016

Related U.S. Application Data
(60) Provisional application No. 62/250,042, filed on Nov. 3, 2015.
(60) Provisional application No. 62/270,479, filed on Dec. 21, 2015.
(60) Provisional application No. 62/396,122, filed on Sep. 17, 2016.

(51) Int. Cl. A24F 15/00; B65D 43/16; H02J 7/00; B65D 25/10; A24F 47/00; B65D 25/04; B65D 85/00

(52) U.S. Cl. CPC A24F 15/00; B65D 25/04; B65D 43/16; B65D 85/54; B65D 25/10; A24F 47/008; H02J 7/0044; H02J 7/0047

(57) ABSTRACT

A case includes a drawer within a cover. The cover includes magnetic material. The drawer includes a first magnetic element at a first end and a second magnetic element at a second end whereby the cover magnetic material moves between the magnetic elements. The magnetic attraction between the magnetic material and second magnetic element retains the drawer within the cover. The magnetic attraction between the magnetic material and first magnetic element retains the drawer in an open configuration. A tray received by the drawer holds components of a vaporizer pen. Optionally, the tray includes a battery subassembly for charging the power supply of a vaporizer pen. Optionally, the tray includes contacts connected to a battery subassembly, whereby the contacts electrically connect to a coupler on the vaporizer pen for charging the power supply of a vaporizer pen.

### CROSS-REFERENCE TO RELATED APPLICATIONS

This application claims priority in U.S. Provisional Application No. 62/250,042, filed Nov. 3, 2015, U.S. Provisional Application No. 62/270,479, filed Dec. 21, 2015, and U.S. Provisional Application No. 62/396,122, filed Sep. 17, 2016, the contents of which are hereby incorporated by reference.

### BACKGROUND

1. Field of the Invention

The disclosed subject matter relates to a case, in particular a case for a vaporizer pen and accessories.

2. Background

Portable devices for vaporizing a liquid concentrate for inhalation may include various components and accessories. The vaporizer components include a mouthpiece, a heating element, and a power supply. Vaporizer accessories include the wax or liquid concentrate, a container for the concentrate, and an applicator. A dabber or applicator device is used to remove liquid concentrate from the container and apply it to the reservoir feeding the heating element, and for removing the accumulation of residue from the vaporizer device. A power supply necessary to operate or recharge the heating element may also be necessary. It is desirable to have the assorted components together and protected from damage.

### SUMMARY

A case with replaceable trays for organizing and protecting the components of a vaporizer pen includes a drawer movably received within a cover. The cover has a body extending between a first end and a second end defining an interior bound by a top wall, an opposing bottom wall, a first side wall, and an opposing second side wall. The first end forms a first oval-shaped opening, and the second end forms a second oval-shaped opening. A post of magnetic material is located at the interior bottom wall adjacent the first end.

The drawer is slidably received within the cover, and the drawer includes a bottom wall extending between a first end and a second end, and a first end wall at the first end and an opposing second end wall at the second end. The bottom wall forms a first curved side wall and an opposing second curved side wall extending between the first end wall and second end wall. An elongated opening formed by the bottom wall extends between the first end and the second end. A first component of magnetic material is disposed at the first end of the elongated opening, and a second component of magnetic material disposed at the second end of the elongated opening. The post travels within the elongated opening between the first and second components.

In an embodiment, the first magnetic component is a magnet, the second magnetic component is a magnet, and the post is composed of material attracted to the first magnetic component and the second magnetic component. In an embodiment, the post is a magnet, the first magnetic component is composed of material attracted to the post, and the second magnetic component is composed of material attracted to the post.

In an embodiment, the tray is a flexible body received in the drawer. The tray extends between a first end and a second end forming a top face with a second depression between a first depression and a third depression. The third depression extends between the body first end and body second end forming opposing first and second side walls. The body forms a first retention member extending upward from the top face adjacent the third depression first side wall and inward from the top face over the third depression, and a second retention member opposite the first retention member, with the second retention member extending upward from the top face adjacent the third depression second side wall and inward from the top face over the third depression. The third depression is dimensioned to cradle a vaporizer pen, and the first and second retention members partially circumscribe the pen to retain the pen within the third depression. The flexible nature of the tray allows the retention members to deform allowing the pen to be inserted and removed from the third depression. A channel in the bottom of the tray extends between the tray first end and the second end allowing passage of the post. In an embodiment, the tray body includes a gap and a divider extends upward from the drawer bottom wall into the gap for positioning the tray in the drawer.

In an embodiment, the third depression first and second side walls taper inward as the walls transition from a point about the midpoint between the body first and second ends toward the body second end for accommodating the shape of various vaporizing pens.

In an embodiment, the tray includes a fourth depression located adjacent the third depression. The fourth depression extends between the body first end and body second end forming opposing first and second side walls. The body forms a first retention member extending upward from the top face adjacent the fourth depression first side wall and inward from the top face over the fourth depression, and a second retention member opposite the first retention member, with the second retention member extending upward from the top face adjacent the fourth depression second side wall and inward from the top face over the third depression. In an embodiment, the fourth depression is dimensioned to cradle a charger for the vaporizer pen, and the first and second retention members partially circumscribe the charger to retain the charger within the fourth depression. The flexible nature of the tray allows the retention members to deform allowing the charger to be inserted and removed from the fourth depression.

In an embodiment, the fourth depression is replaced by a battery subassembly for recharging the vaporizer pen in the third depression. The battery assembly generally includes a battery compartment with a battery operably connected to a contact accessible from the third depression. In use, a vaporizer pen having a power supply with a contact matching the battery assembly contact is stored in the case when not in use and the battery in the case recharges the power supply. In an embodiment, a connector accessible at the exterior of the case is operably connected to the battery and the pen power supply for charging the battery and the pen power supply. The battery subassembly includes circuitry connecting the battery, connector, and contacts. The battery assembly may also include indicator lights visible from the exterior of the case indicating the charge state of the battery and pen power supply, and the charging state of the battery subassembly.

In an embodiment, the tray includes a container received within the first depression. The container includes a body forming an interior defined by side walls extending upward from a bottom wall, where the side walls form a groove at the interior. A removable lid seals the body. The lid includes an upper portion and a bottom wall depending from the upper portion, the bottom wall forms a lip engaging the body groove for sealing the container and any liquid concentrate therein. In an embodiment, the tray includes a depression retaining an applicator device.

When in use, drawer is in a closed configuration when the post is in contact with the first magnetic component and the drawer bottom wall is within the cover. The drawer is in an open configuration when the post is in contact with the second magnetic component and the drawer second end wall is within the cover. The drawer is transitioned from the closed configuration to the open configuration by moving the drawer second end wall toward the cover first opening whereupon the magnetic attraction between the post and the second contact draw the components together holding the drawer in a position whereby the vaporizer components and accessories are accessible to the user.

In an embodiment, the drawer and tray accommodate a power supply connected to contacts. The contacts reside in the depression in the tray for the vaporizer pen. A coupler joining the vaporizer pen power source and atomizer mates with the contacts when the pen assembly is placed in the tray allowing the power supply in the case to charge the power supply of the vaporizer pen.

### BRIEF DESCRIPTION OF THE DRAWINGS

The present disclosed subject matter is described herein with reference to the following drawing figures, with greater emphasis being placed on clarity rather than scale:

FIG. 1 is an isometric view of a case embodying aspects of the disclosed subject matter, where the case is in an open configuration.

FIG. 2 is an isometric view of the case in a closed configuration.

FIG. 3 is an isometric view of the cover.

FIG. 4 is a bottom view of the cover.

FIG. 5 is an end view of the cover.

FIG. 6 is an isometric view of the drawer.

FIG. 7 is a top view of the drawer.

FIG. 8 is a bottom view of the drawer.

FIG. 9 is an isometric view of the case in an open configuration whereby the drawer is extended from the cover.

FIG. 10 is an isometric view of a tray embodying aspects of the disclosed subject matter.

FIG. 11 is a top plan view of the tray of FIG. 10.

FIG. 12 is a bottom plan view of the tray of FIG. 10.

FIG. 13 is an isometric view of an alternative embodiment tray embodying aspects of the disclosed subject matter.

FIG. 14 is a top plan view of the tray of FIG. 13.

FIG. 15 is a bottom plan view of the tray of FIG. 13.

FIG. 16 is an isometric view of an alternative embodiment tray embodying aspects of the disclosed subject matter.

FIG. 17 is a top plan view of the tray of FIG. 16.

FIG. 18 is a bottom plan view of the tray of FIG. 16.

FIG. 19 is an isometric view of the container.

FIG. 20 is an exploded view of the container of FIG. 19.

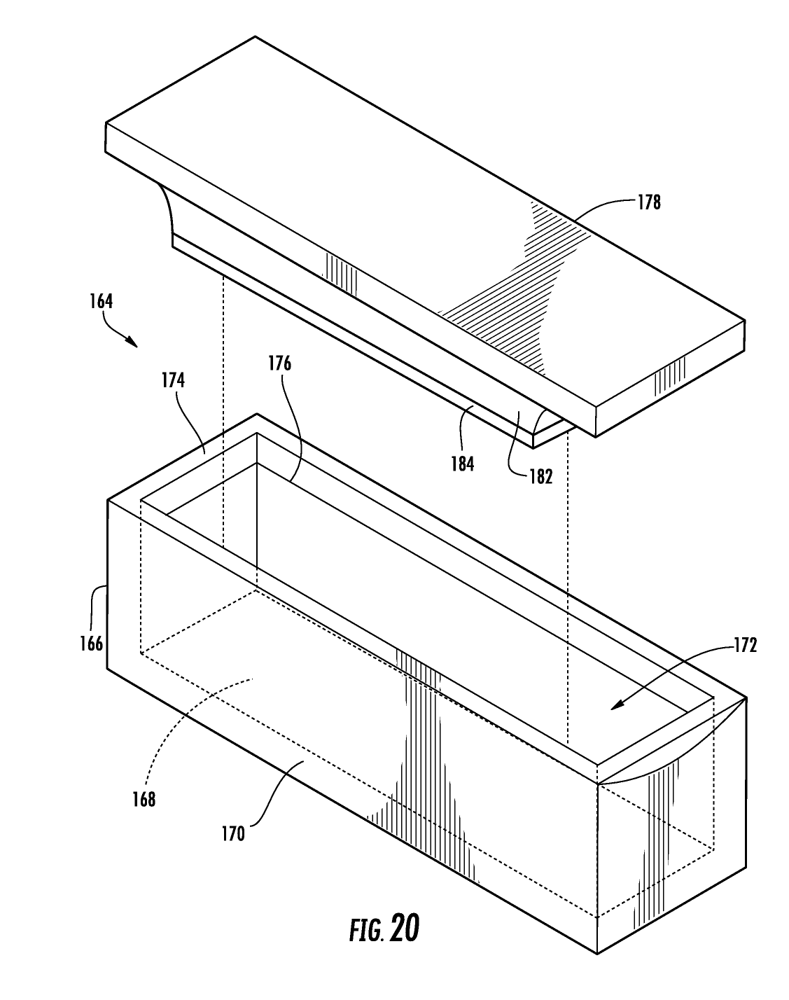

FIG. 21 is a front isometric view of an alternative embodiment drawer and tray embodying aspects of the disclosed subject matter.

FIG. 22 is a rear isometric view of the drawer and tray of FIG. 22.

FIG. 23 is a rear isometric view of the article assembly.

FIG. 24 is a rear isometric view of the battery subassembly.

FIG. 25 is a rear isometric view of article assembly and the battery subassembly with circuitry.

FIG. 26 is a rear isometric view of the subassemblies of FIG. 25 with the battery cover and button.

FIG. 27 is an isometric view of a case embodying aspects of the disclosed subject matter, where the case is in an open configuration.

FIG. 28 is a side view of the case of FIG. 27 showing the cap.

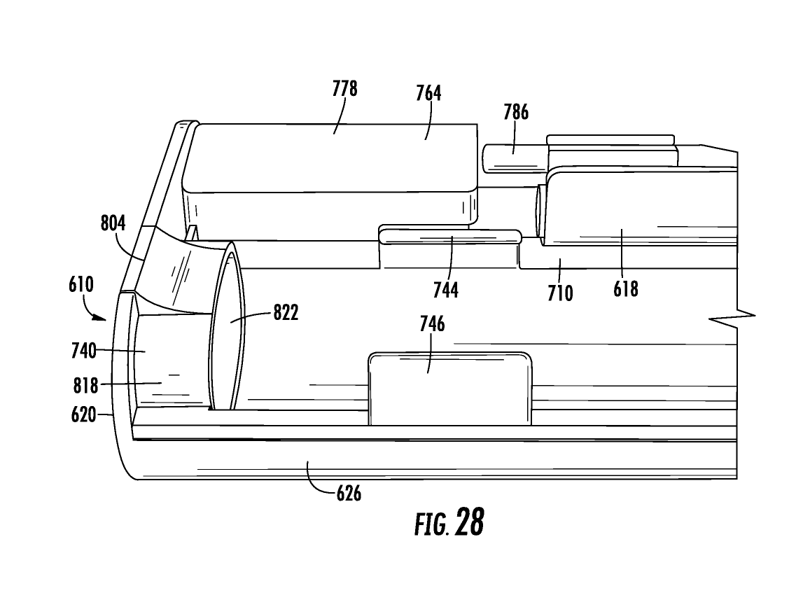

FIG. 29 is an end view of case of FIG. 27 showing the interior of the cap.

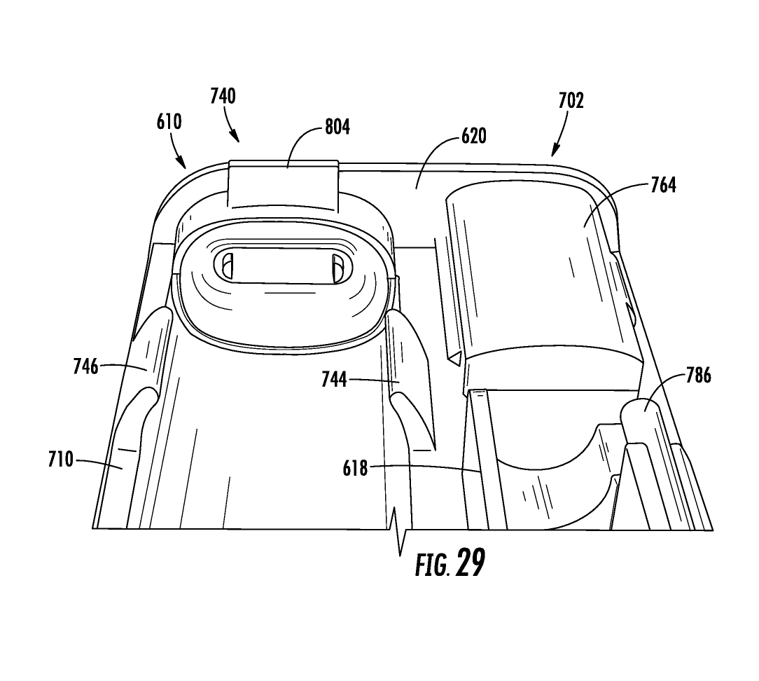

FIG. 30 is an isometric view of the drawer.

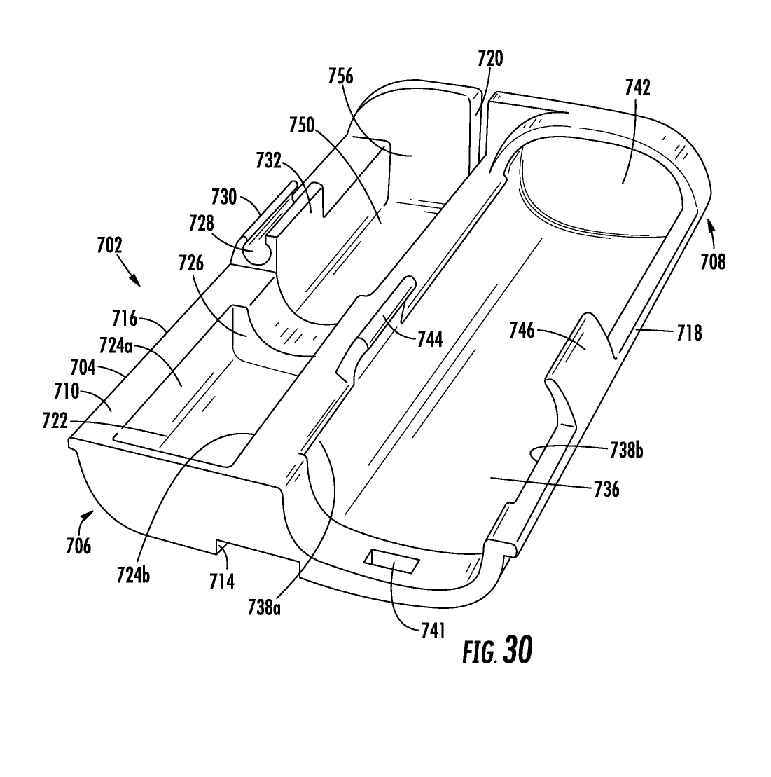

FIG. 31 is an isometric view of the tray.

FIG. 32 is an isometric view of the interior of the cap.

FIG. 33 is an isometric view of the exterior of the cap.

FIG. 34 is an isometric view of the container.

FIG. 35 is an isometric view of a case embodying aspects of the disclosed subject matter, with contacts residing in the depression in the tray for the vaporizer pen.

FIG. 36 is an isometric view of the case with the coupler joining the atomizer and rechargeable battery disposed in the vaporizer pen depression of the tray.

FIG. 37 is an isometric view of the tray with the battery cover removed, and the charging system removed.

FIG. 38 is an isometric view of the charging system.

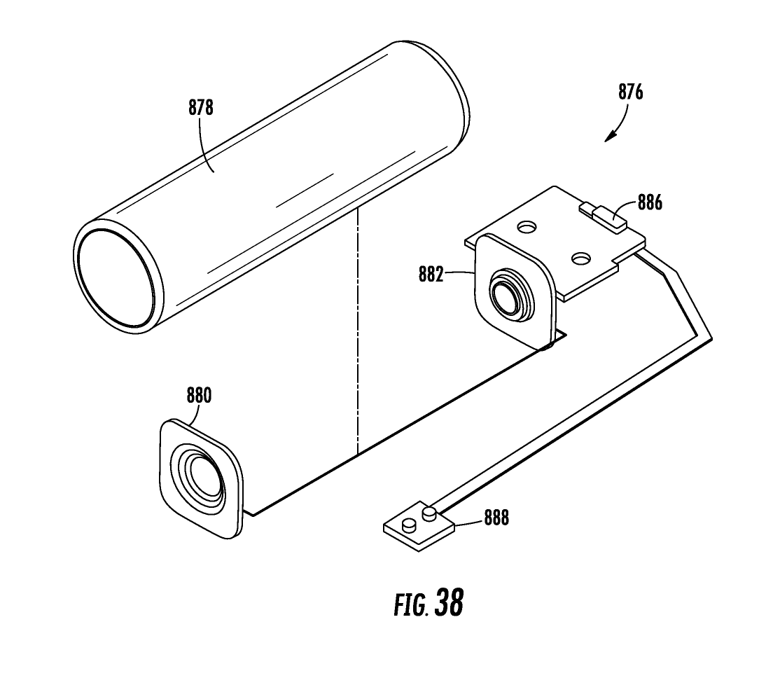

FIG. 39 is a view of the coupler.

FIG. 40 is a section view of the coupler.

FIG. 41 is an enlargement of the upper portion of FIG. 40.

FIG. 42 is an enlargement of the middle portion of FIG. 40.

FIG. 43 is an enlargement of the lower portion of FIG. 40.

FIG. 44 is an enlargement of the bottom connector.

FIG. 45 is an elevation view of an embodiment of the main body.

FIG. 46 is an isometric view from the bottom of the main body of FIG. 45.

FIG. 47 is an isometric view from the top of the main body of FIG. 45.

FIG. 48 is an isometric view of an embodiment of the contact insulator.

FIG. 49 is an isometric view of an alternative embodiment main body.

FIG. 50 is an isometric view of an alternative embodiment contact insulator.

### DETAILED DESCRIPTION

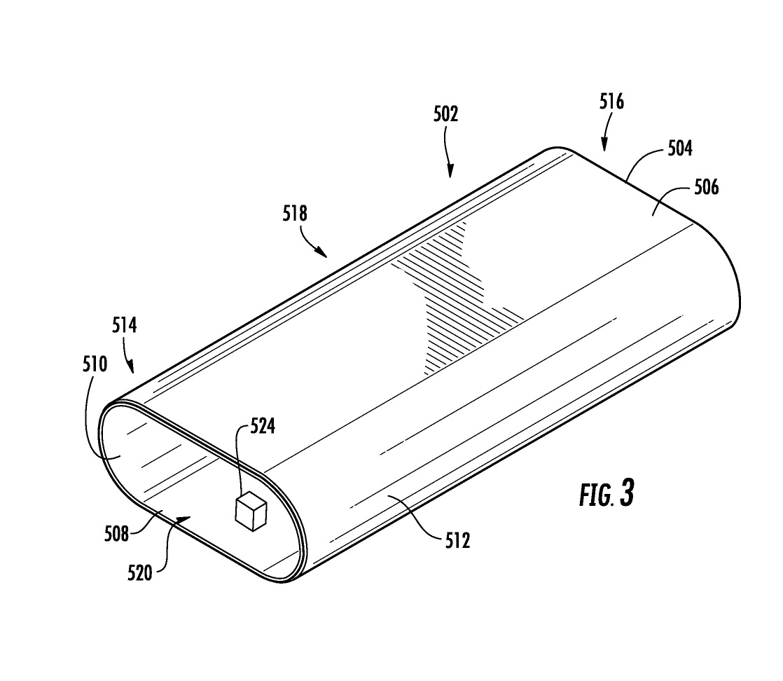

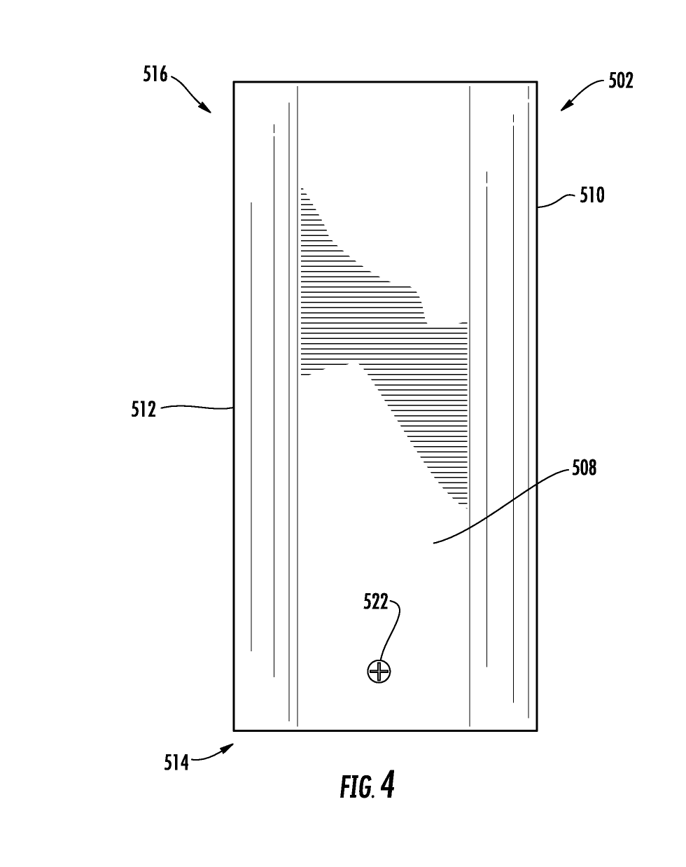

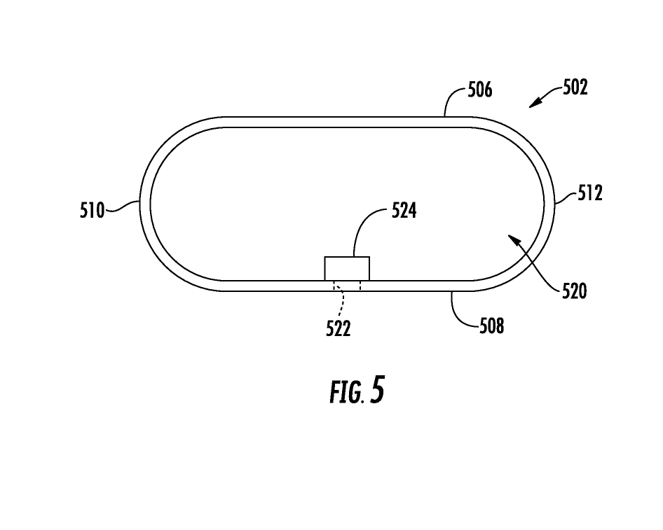

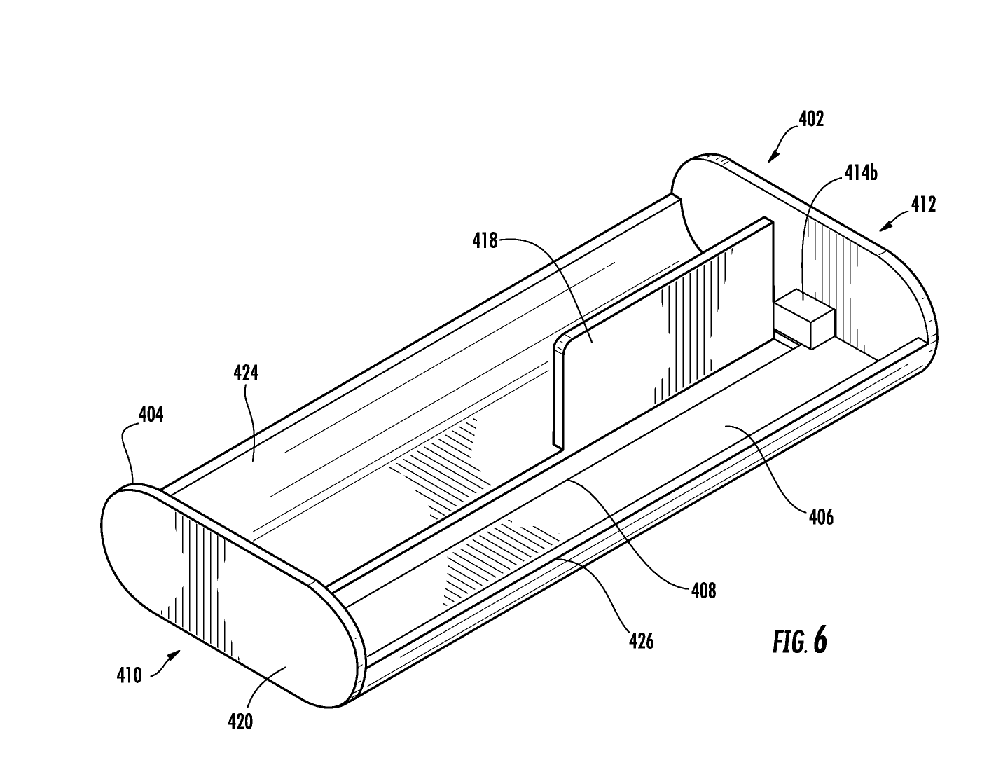

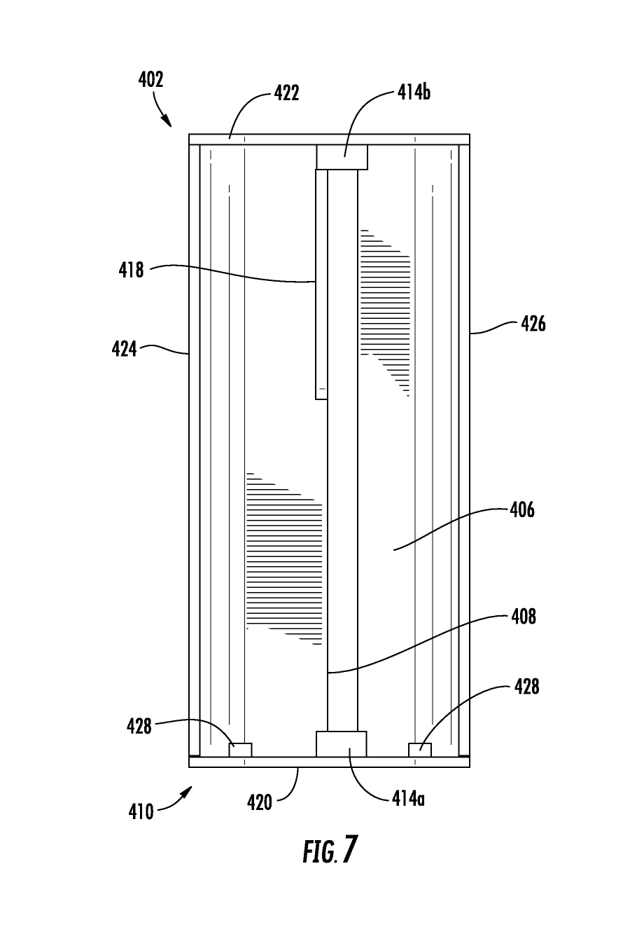

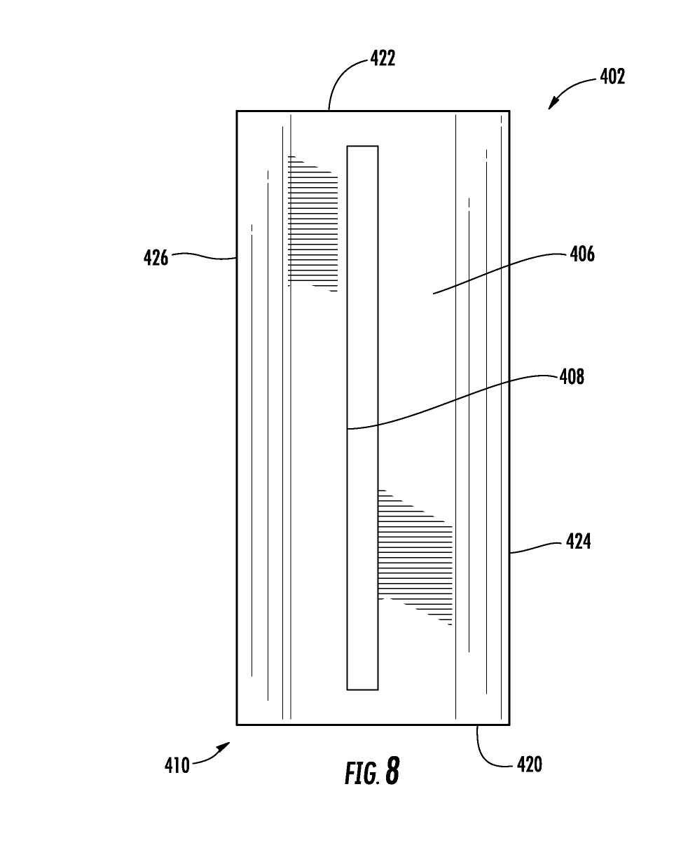

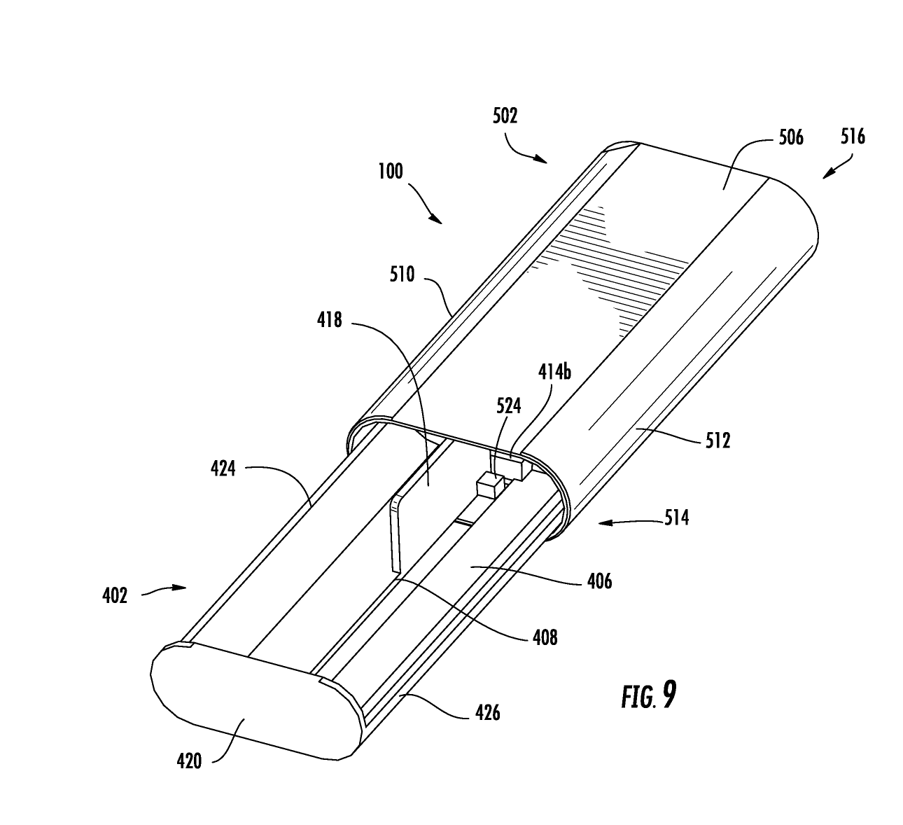

Referring to the drawings, a case 100 with replaceable trays for organizing and protecting the components of a vaporizer pen is shown and described. Referring to FIGS. 3-9, the case 100 has a drawer 402 slidably moveable within a cover 502. The cover 502 has a body 504 forming a generally rectangular tubular cylinder extending between an open generally oval shaped first end 514 and an open generally oval shaped second end 516. The body 504 has a top wall 506 opposite a bottom wall 508 connected by a first side wall 510 and an opposite second side wall 512. In an embodiment, the body 504 is formed from metal, including extruded aluminum. A post 524 adjacent the first end 514 extends from the bottom wall 508 into the interior 520 of the cover 502 for interacting with elements at each end of the drawer 402. The post 524 may be secured to the cover 502 by passing a threaded fastener from the exterior 518 through a hole 522 into a threaded opening in the post 524.

The drawer 402 has a body 404 with a bottom wall 406 extending between a first end wall 420 at a first end 410, and a second end wall 422 at a second end 412. A curved first side wall 424 and an opposite curved second side wall 426 extend upward from the bottom wall 406 and extend between the first end 410 and second end 412. The bottom wall 406 and side walls 424, 426 form a generally concave bottom to the drawer 402. In an embodiment, the drawer 402 is sized to conform to the interior 520, with the first and second end walls 420, 422 conforming to the generally oval shaped ends 106, 108 and the side walls 424, 426 conforming to side walls 510, 512, respectively. The bottom wall 406 forms an elongated opening 408 extending between the first end 410 and second end 412 accommodating passage of the post 524 therebetween. Element 414a contacts the post 524 when the drawer 402 is positioned in a closed position within the cover 502, and element 414b contacts the post 524 when the drawer 402 is positioned in an open position with the drawer 402 extending from the cover 502. A divider 418 extends upward from the bottom wall 406 adjacent the opening 408 for aligning the tray within the drawer 402. Prongs 428 extend from the first end wall 420 into the interior of the drawer 402 for retaining the end of the tray within the drawer 402. In an embodiment, the drawer 402 is manufactured from a rigid material, including plastic.

In an embodiment, the post 524 includes magnetic material, and elements 414a, b include magnetic material. In an embodiment, the post 524 includes magnetic material, and elements 414a, b include material that produces a magnetic field. In an embodiment, the post 524 includes material that produces a magnetic field and elements 414a, b include magnetic material. In an embodiment, the magnetic material is ferromagnetic material.

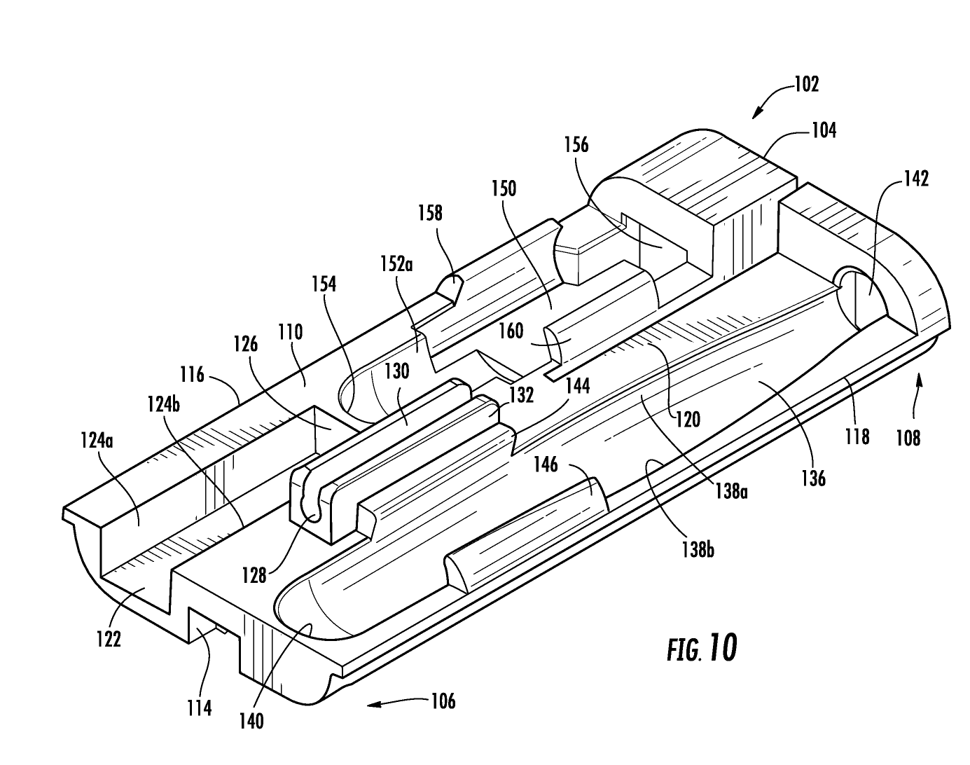

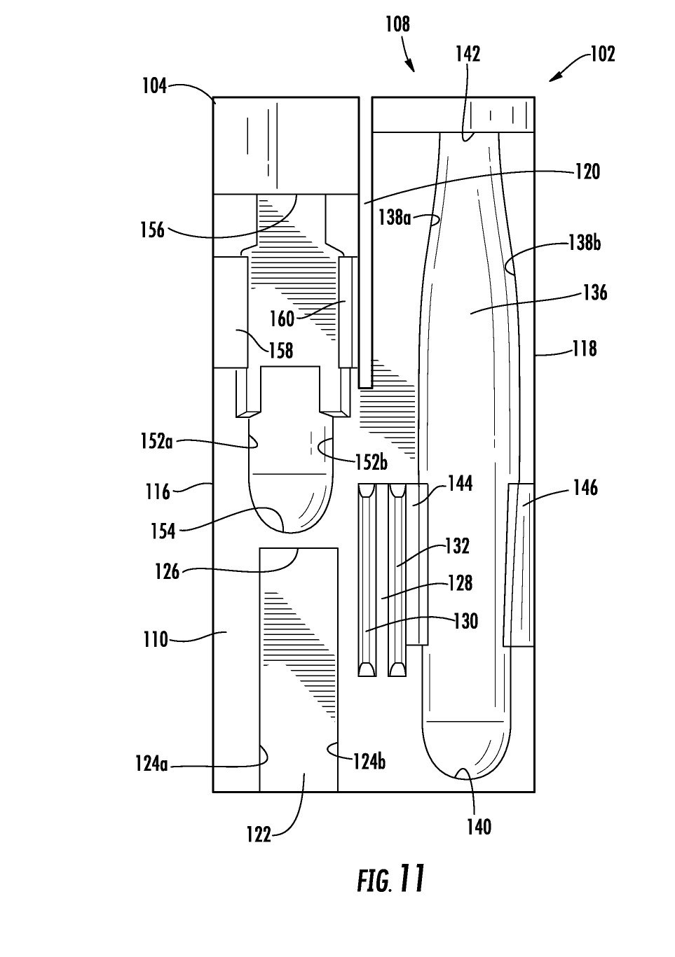

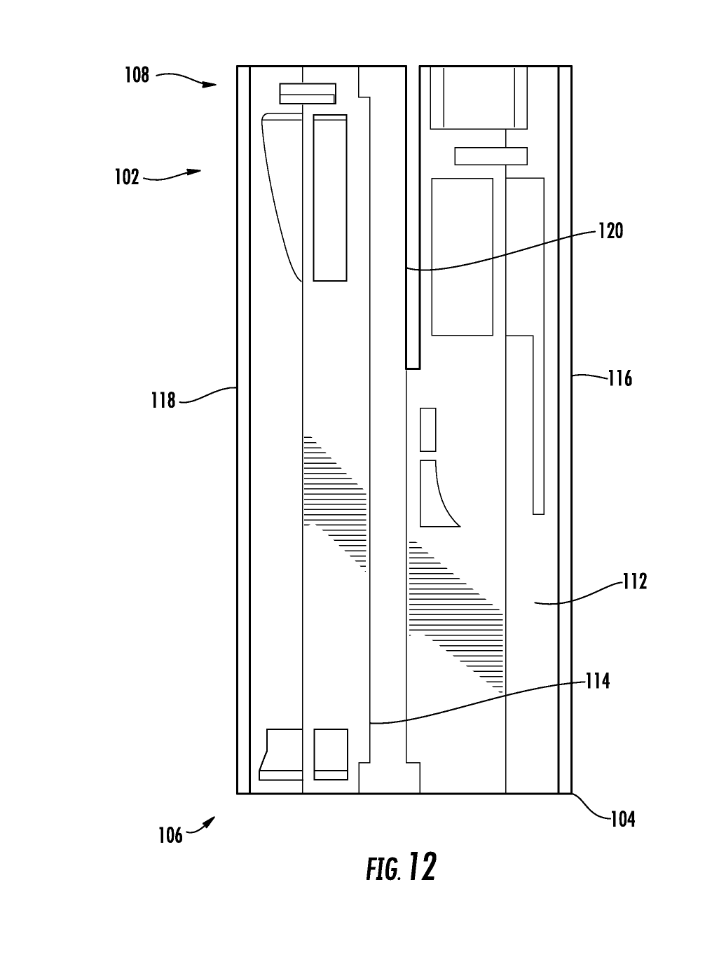

Referring to FIGS. 10-12, an embodiment of the case 100 includes a tray 102 with various depressions for vaporizer components and accessories. The tray 102 includes a body 104 having a length extending between a first end 106 and a second end 108, and a width extending between a first side 116 and a second side 118. The top face 110 of the body 104 forms a first depression 122 for a container 164, a second depression 128 for a dab tool 186, a third depression 136 for a vaporizer pen 188, and a fourth depression 150 for a connecting cord or a vaporizer pen charging apparatus 190. The first depression 122 is at the first end 106 adjacent the first side 116 and includes opposing side walls 124a, b, and an end wall 126 opposite an opening at the first end 106. The third depression 136 extends between the first end 106 and the second end 108 adjacent the second side 118 forming a first end wall 140 opposite a second end wall 142 connected by opposing side walls 138a, b. The side walls 138a, b taper slightly inward as the walls transition from a point about the midpoint of the side walls toward the second end wall 142. The first end wall 140 provides room at the base of the vaporizer pen 188 allowing removal of the pen 188 by a finger. The second end wall 142 provides a notch for retaining the tip of the pen 188. A first retention member 144 and opposing second retention member 146 extend upward and inward from the top face 110 over the third depression 136 to partially circumscribe and retain the pen 188 in the depression 136. The second depression 128 is between the first depression 122 and third depression 136 adjacent the first end 106. The second depression 128 has a first side wall 130 and opposing second side wall 132 with an inner protrusion extending inward forming a channel for retaining the dab tool 186. The fourth depression 150 is adjacent the third depression 136 above the first depression 122. The fourth depression 150 extends between end wall 126 and the second end 108 forming a first end wall 154 and an opposite second end wall 156 connected by opposing side walls 152a, b. The first end wall 154 provides room at the base of the charger 190 allowing removal of the charger by a finger. The second end wall 156 provides a notch for retaining the tip of the charger 190. A first retention member 158 and opposing second retention member 160 extend upward and inward from the top face 110 over the fourth depression 150 to partially circumscribe and retain the charger 190 in the depression 150. A gap 120 extending through the body 104 between the third depression 136 and fourth depression 150 is dimensioned to receive the divider 418 to position the tray 102 in the drawer 402. In an embodiment, the divider 418 extends into a depression in the bottom 112 of the body 104 to position the tray 102 in the drawer 402.

The bottom 112 of the body 104 forms a channel 114 extending between the first end 106 and the second end 108 allowing passage of the post 524 as it moves between elements 414a and 414b.

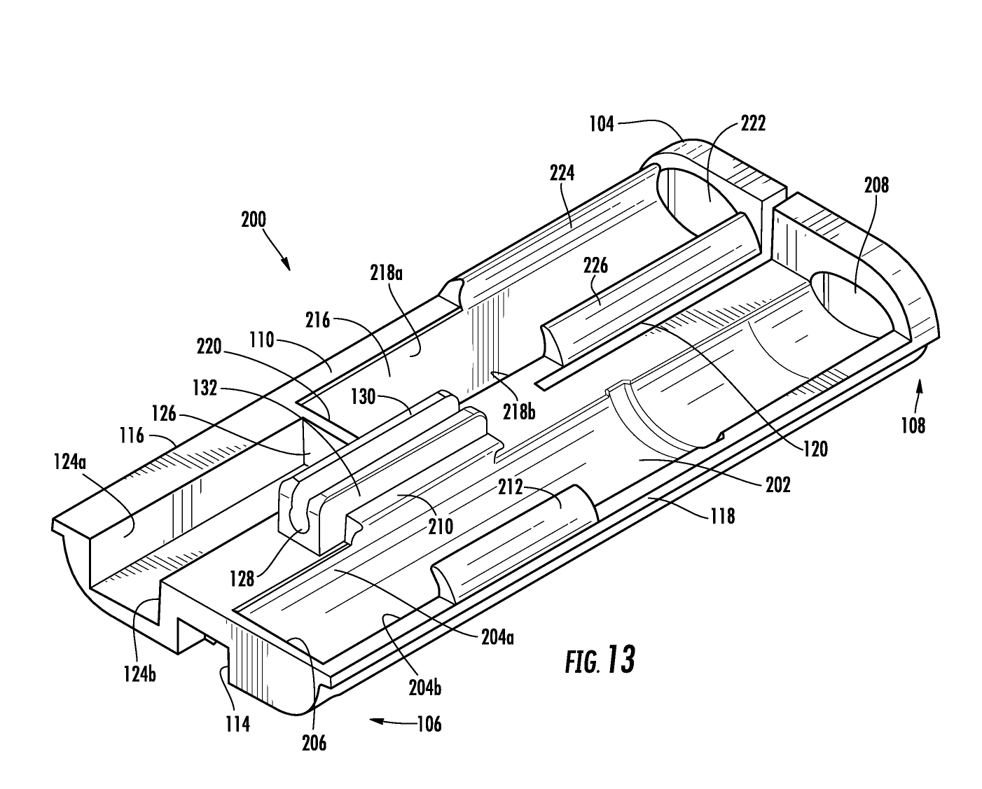

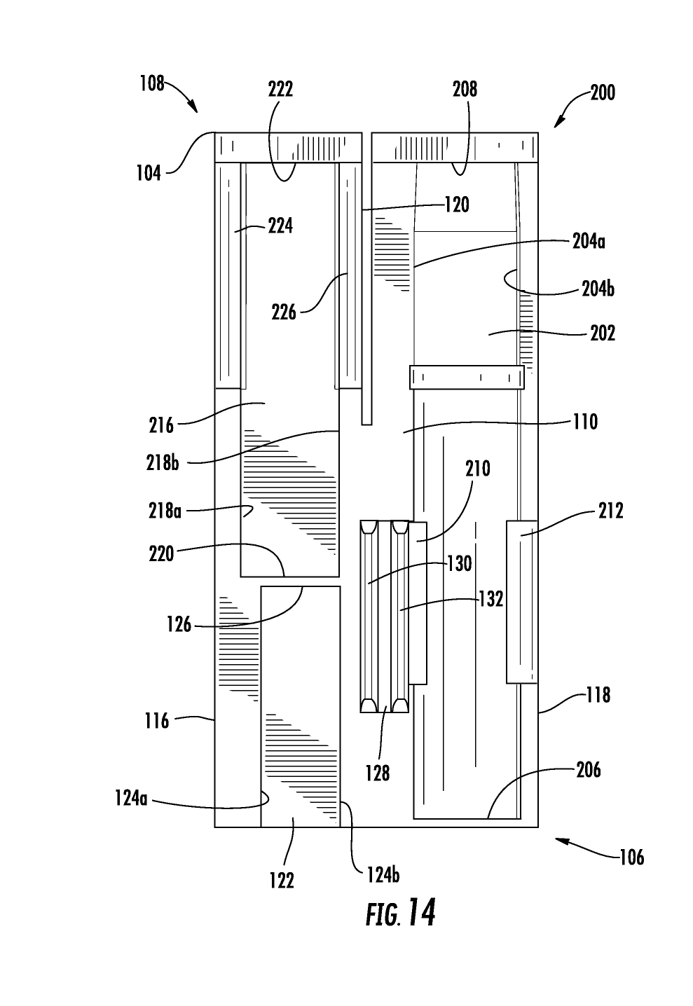

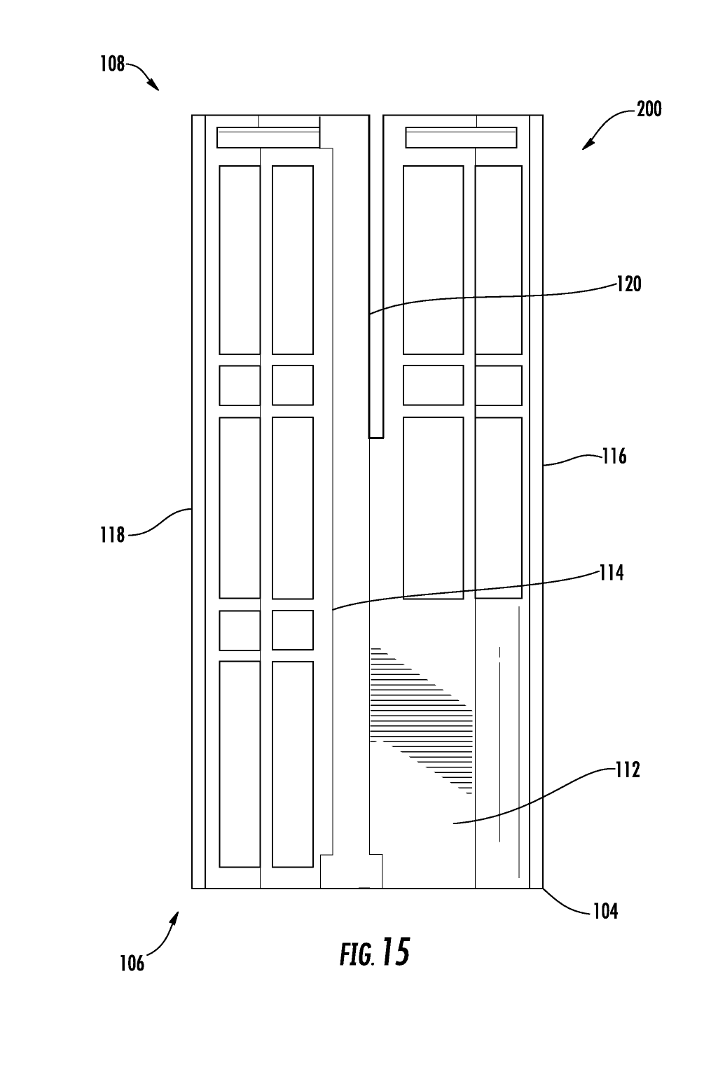

Referring to FIGS. 13-15, an alternative embodiment tray 200 is shown and described. Tray 200 includes a first depression 122, a second depression 128, a gap 120, and a channel 114, however the third and fourth depressions of tray 102 are different from the third and fourth depressions 202, 216 of tray 200. The third depression 202 extends between the first end 106 and the second end 108 adjacent the second side 118 forming a first end wall 206 opposite a second end wall 208 connected by opposing side walls 204a, b. The first end wall 206 provides room at the base of the pen 188 allowing removal of the pen 188 by a finger. The second end wall 208 provides a notch for retaining the tip of the pen 188. A first retention member 210 and opposing second retention member 212 extend upward and inward from the top face 110 over the third depression 202 to partially circumscribe and retain the pen 188 in the depression 202.

The fourth depression 216 is adjacent the third depression 202 above the first depression 122. The fourth depression 216 extends between first end wall 126 and the second end 108 forming a first end wall 220 and an opposite second end wall 222 connected by opposing side walls 218a, b. The first end wall 220 provides room at the base of the charger 190 allowing removal of the charger by a finger. The second end wall 222 provides a notch for retaining the tip of the charger 190. A first retention member 224 and opposing second retention member 226 extend upward and inward from the top face 110 over the fourth depression 216 to partially circumscribe and retain the charger 190 in the depression 216.

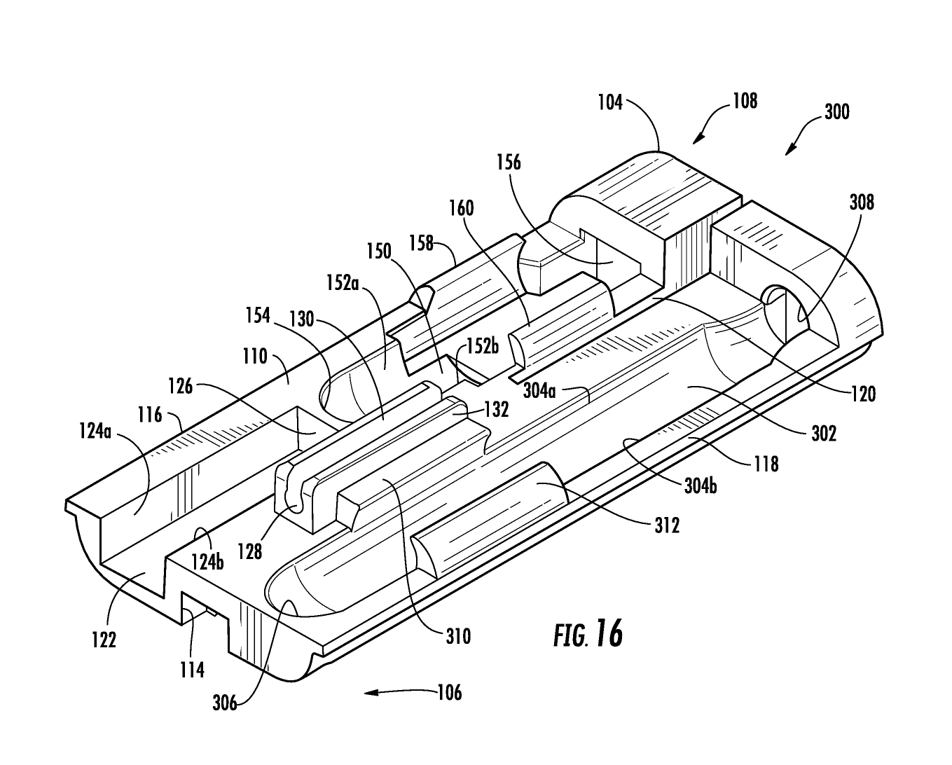

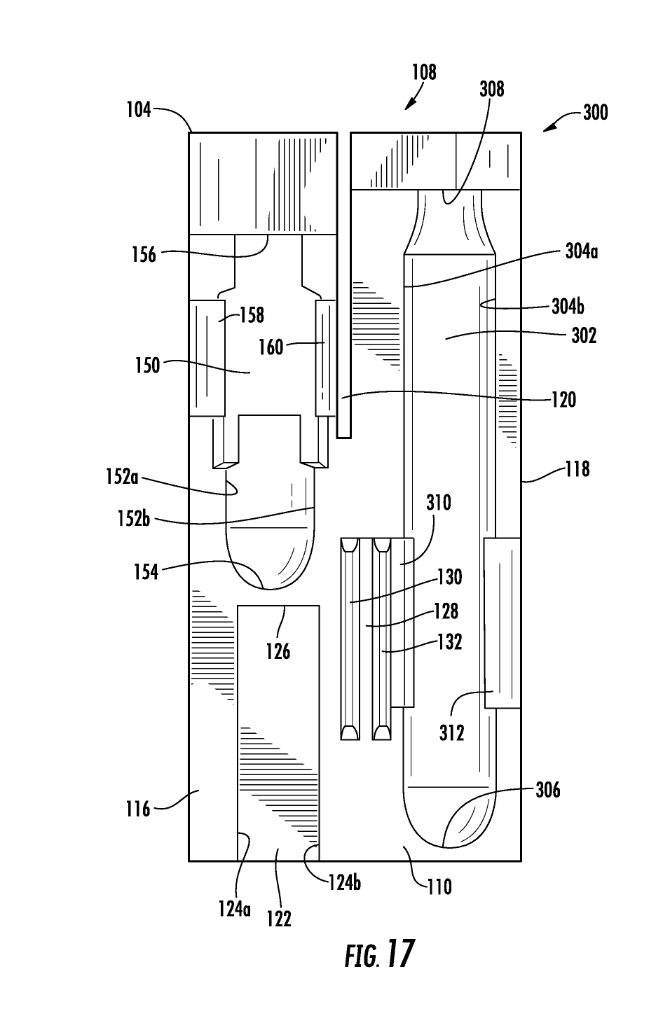

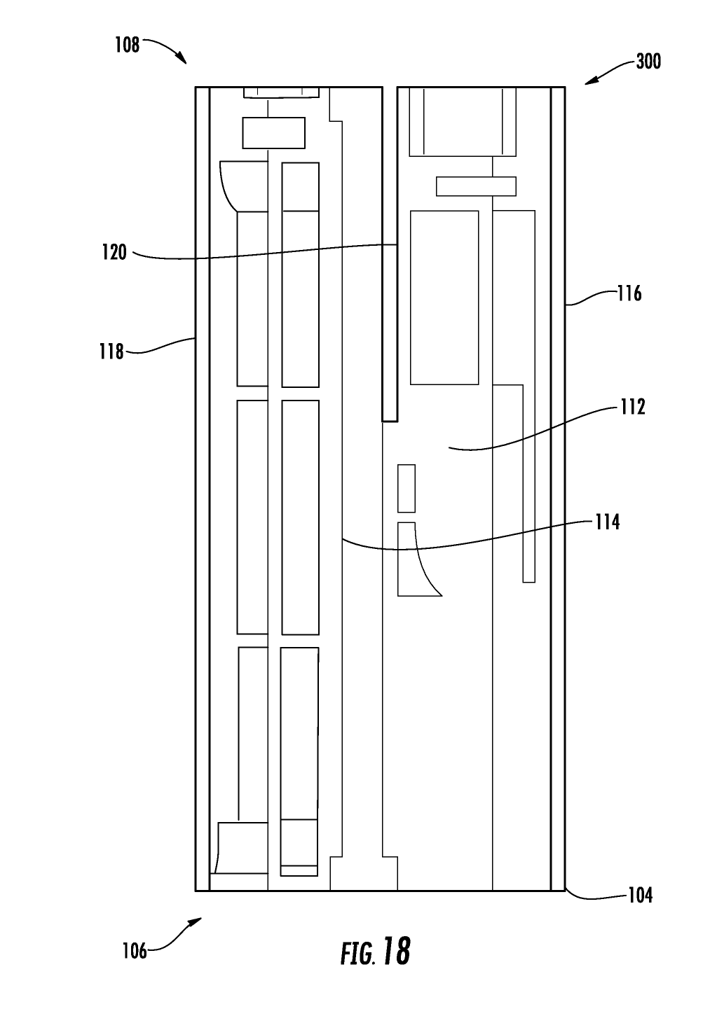

Referring to FIGS. 16-18, an alternative embodiment tray 300 is shown and described. Tray 300 includes a first depression 122, a second depression 128, a fourth depression 150, a gap 120, and a channel 114, however the third depression of tray 102 is different from the third depression 302 of tray 300. The third depression 302 extends between the first end 106 and the second end 108 adjacent the second side 118 forming a first end wall 306 opposite a second end wall 308 connected by opposing sidewalls 304a, b. The side walls 304, b taper slightly inward as the walls transition from a point about adjacent the second end wall 308 to the second end wall 308. The first end wall 306 provides room at the base of the pen 188 allowing removal of the pen 188 by a finger. The second end wall 308 provides a notch for retaining the tip of the pen 188. A first retention member 310 and opposing second retention member 312 extend upward and inward from the top face 110 over the third depression 302 to partially circumscribe and retain the pen 188 in the depression 202.

In an embodiment, the trays 102, 200, and 300 are manufactured from a flexible material, including molded silicone.

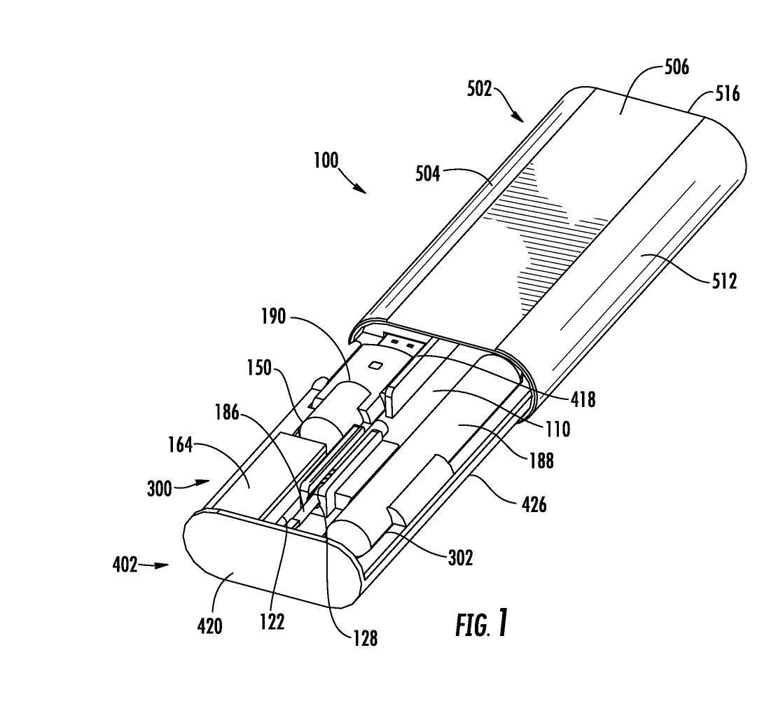

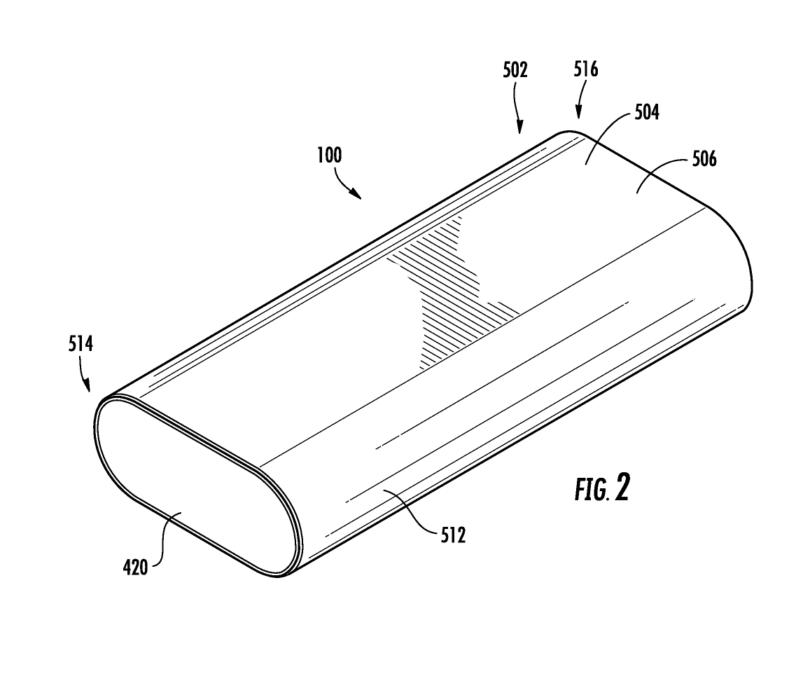

When the case 100 is in the closed configuration (FIG. 2), the post 524 is in contact with element 414a, whereby the magnetic interaction between post 524 and element 414a retains the drawer 402 within the cover 502. The case 100 is transitioned from the closed configuration to an open configuration (FIG. 1) by moving the second end wall 422 toward the first end 514 of the cover 502 overcoming the magnetic attraction between the post 524 and element 414a. As the second end wall 422 approaches the first end 514 the magnetic attraction between the post 524 and element 414b draws the components together holding the drawer 402 in a position whereby the vaporizer components and accessories are accessible. The case 100 is transitioned from the open configuration to the closed configuration by moving the first end wall 420 toward the second end 516 of the cover 502 overcoming the magnetic attraction between the post 524 and element 414b. As the second end wall 422 approaches the second end 516 the magnetic attraction between the post 524 and element 414a draws the components together holding the drawer 402 within the cover 502.

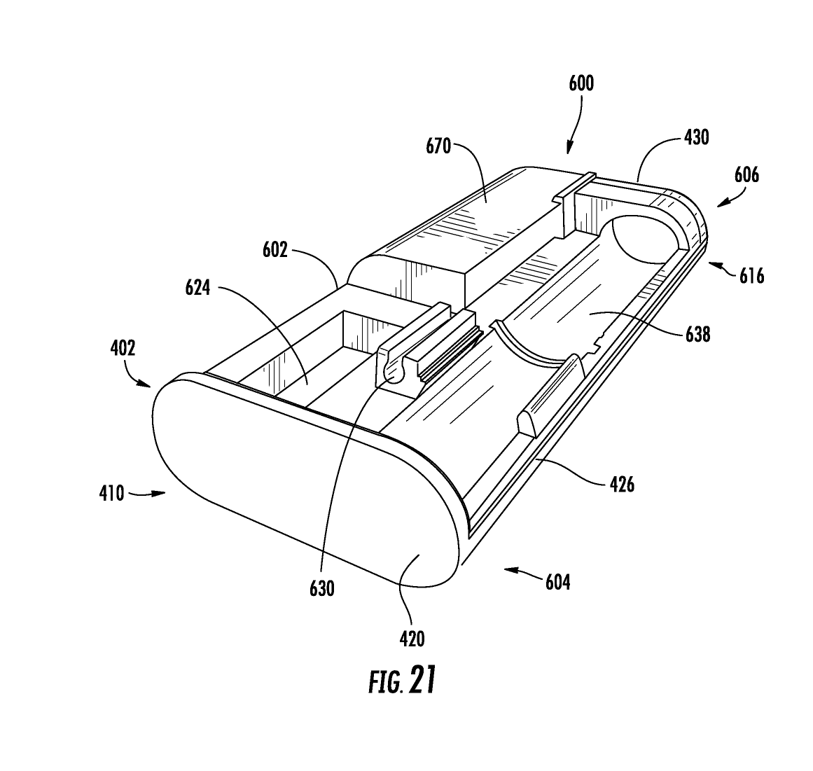

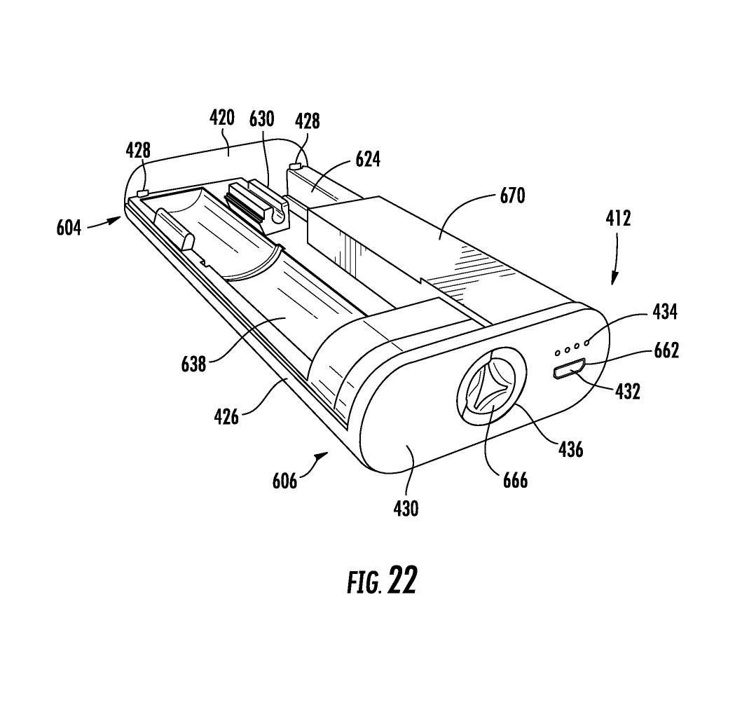

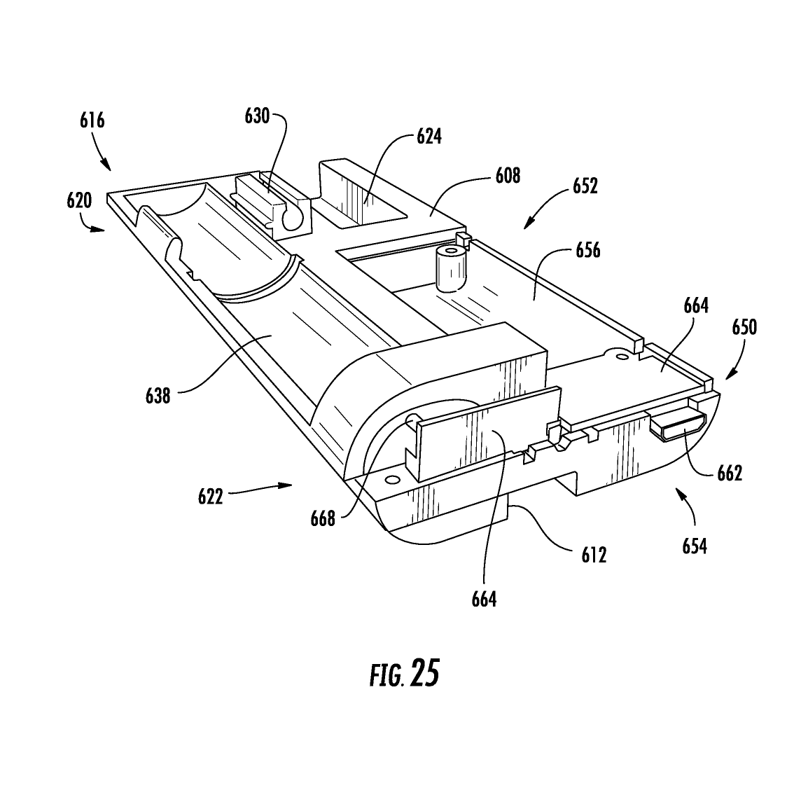

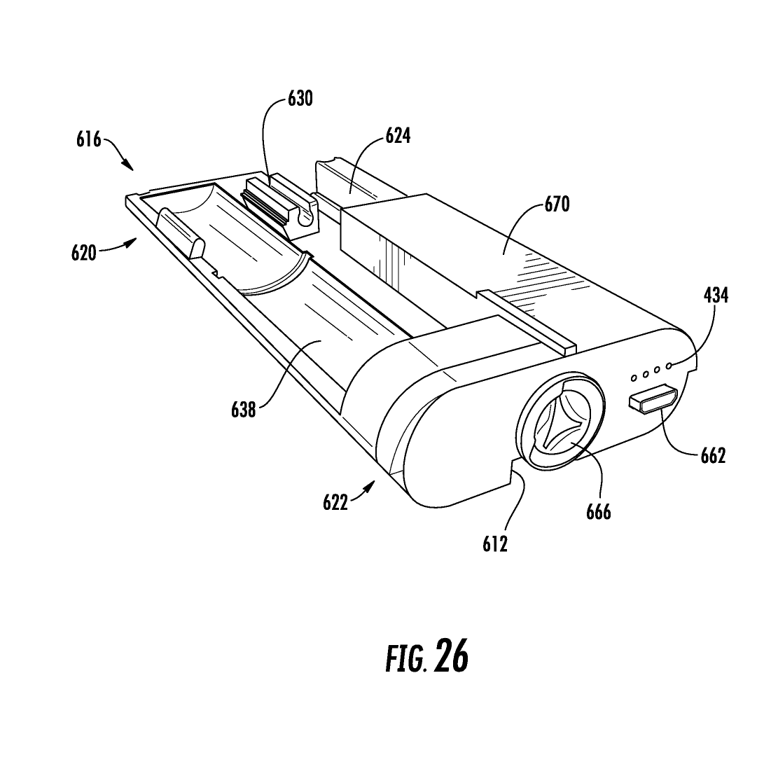

Referring to FIGS. 21-26, an alternative embodiment tray 600 is shown and described having an article subassembly 616 and a battery subassembly 650, whereby the battery subassembly 650 includes a battery, charging and discharging circuitry 664, a connector 662 for connecting to a power source, and a contact 668 accessible from the third depression for connection to the rechargeable vaporizer pen power supply. The tray 600 has a body 602 extending from a first end 604 to a second end 606 and uses a drawer 402 without a divider 418 and with a modified second end wall 430 allowing connection of the battery to an external power source, such as a wall outlet or a battery.

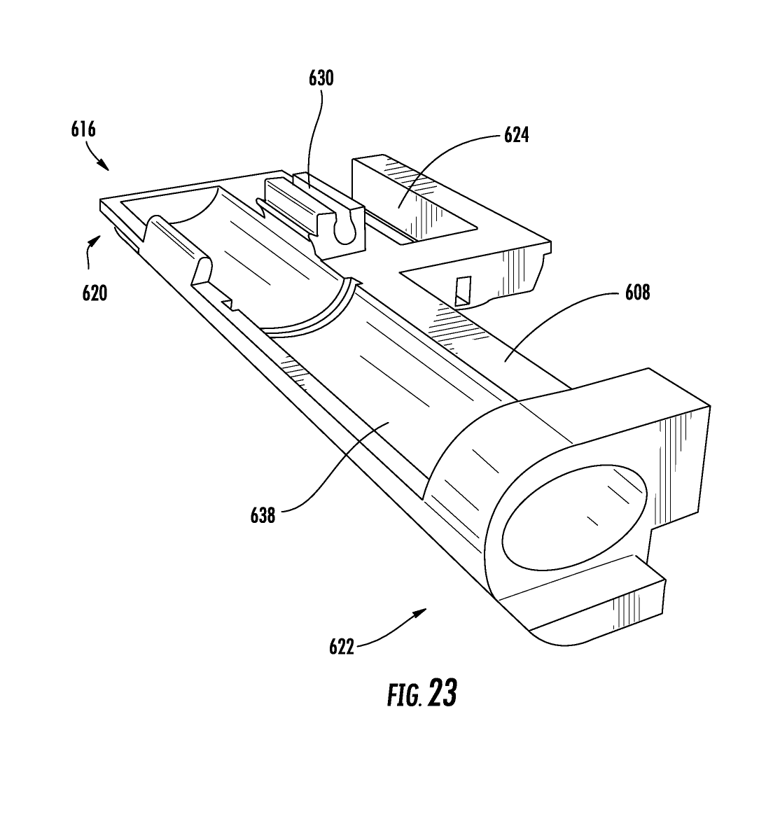

Referring to FIG. 23, the article subassembly 616 extends from a first end 620 to a second end 622. The top 608 of the subassembly 616 forms a first depression 624 for a container 164, a second depression 630 for a dab tool 186, a third depression 638 for a vaporizer pen 188. The first depression 618, second depression 630, and third depression 638 are arranged the same as, and have the same features as, the first depression 122, second depression 128, and third depression 202 respectively of tray 200. The bottom of the subassembly 616 conforms to the walls of the drawer 402 and forms part of the channel 612. The subassembly 616 accommodates the battery compartment 656 of the battery subassembly 650 where generally the fourth depression 150 resides in tray 200.

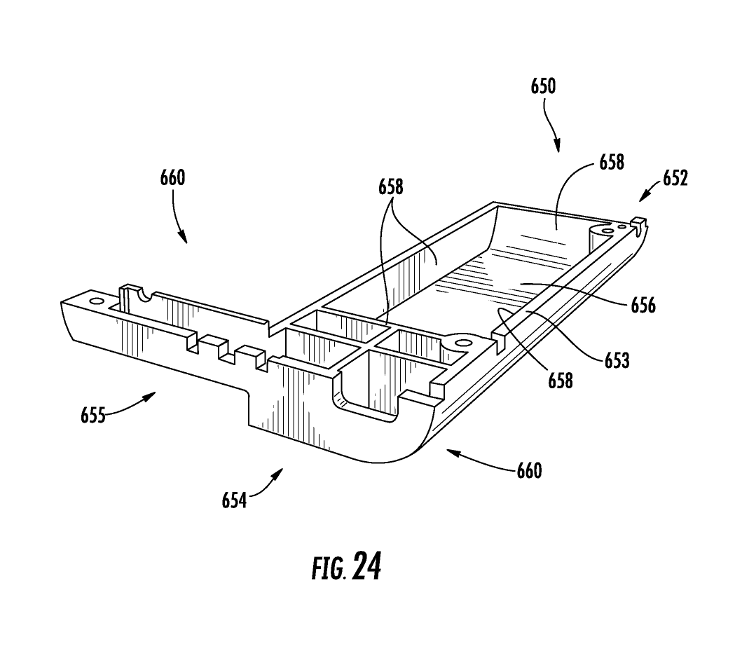

Referring to FIG. 24, the battery subassembly 650 extends from a first end 652 to a second end 654 forming a main body 653 and a lateral compartment 655 extending from the second end 654. The main body 653 includes side walls 658 forming a battery compartment 656 for retaining a rechargeable battery. The second end 654 forms a circuitry bay 660 extending across the second end 654 into a lateral compartment 655. At the second end 654 the circuitry bay 660 forms an opening for an external connector 662, LEDs 674 for indicating battery charging status and battery capacity, and a power button 436 associated with circuitry 664. The lateral compartment 655 forms an opening for an internal contact 668 associated with circuitry 664. The bottom of the subassembly 650 conforms to the walls of the drawer 402 and forms part of the channel 612 allowing the post 524 to move between elements 414a and b. A removable cover 670 seals the battery compartment 656 and the circuitry bay 660. The tray 600 is mounted in the drawer 402 with the second end 606 at the modified second end wall 430.

The modified second end wall 430 includes a central opening 434 for a power button 666 operably connected to the circuitry 664, an adjacent opening 432 for the external connector 662, and openings 434 for the LEDs 674. As above, the drawer 402 with the tray 600 slides in and out of the cover 502.

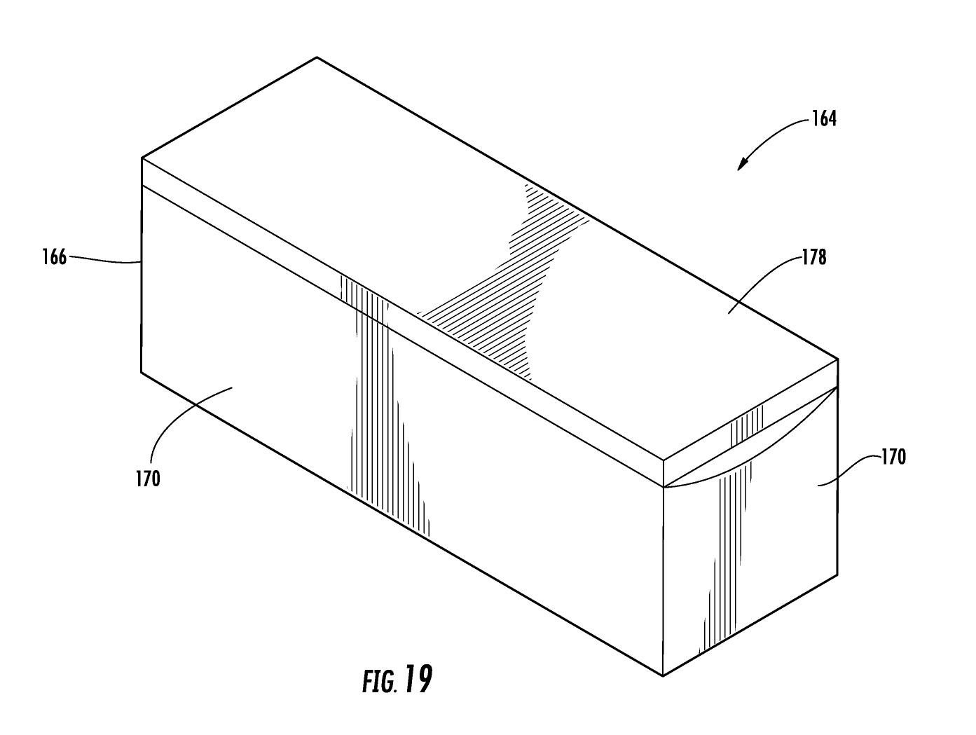

In an embodiment, the trays 102, 200, 300, and 600 include a removable container 164 (FIG. 19) for storing the wax or liquid concentrate used with the pen 188. The container 164 includes a lid 178 that seals to a body 166. The body 166 forms an upwardly open container defined by side walls 170 extending upward from a bottom wall 168 to a top edge 174. A groove 176 circumscribes the interior 172 of the side walls 170 for accepting the lip 184 circumscribing the bottom wall 182 depending from an upper portion of the lid 178. The lid 178 is joined with the body 166 and the lip 184 engages the groove 176 to seal the container 164. The container fits in the first depression 122. In an embodiment, the container 164 is manufactured from a flexible material, including molded silicone.

In an embodiment, the trays 102, 200, 300, and 600 include a removable tool 186 or applicator device for removing liquid concentrate from the container 164 and applying it to the reservoir feeding the heating element of the pen 188, and for removing the accumulation of residue from the pen 188. The tool 186 is manufactured from plastic or metal, including stainless steel.

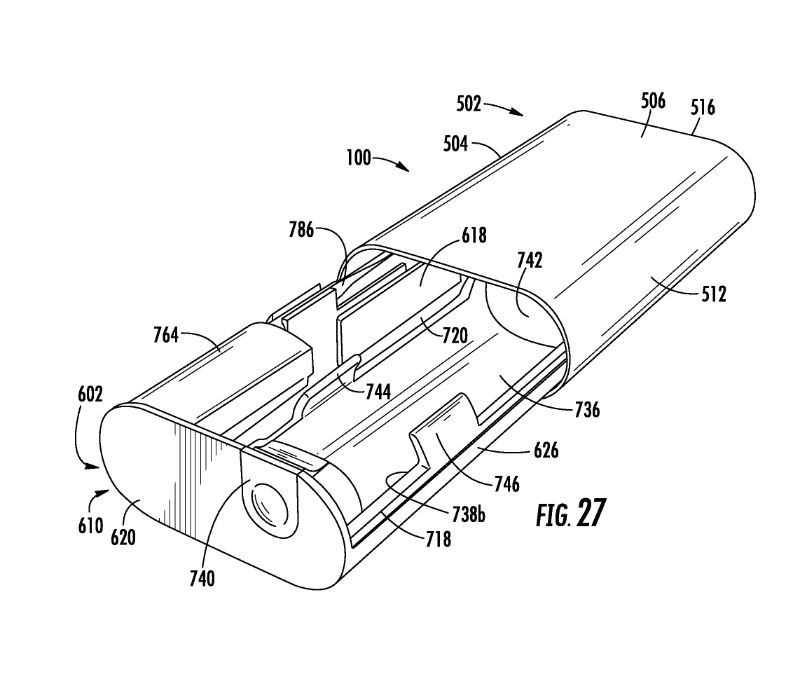

Referring to the drawings, a case 700 with replaceable trays for organizing and protecting the components of a vaporizer pen is shown and described. Referring to FIG. 27, the case 700 has a drawer 602 slidably moveable within a cover 502. The cover 502 has a body 504 forming a generally rectangular tubular cylinder extending between an open generally oval shaped first end and an open generally oval shaped second end 516. The body 504 has a top wall 506 opposite a bottom wall connected by a first side wall and an opposite second side wall 512. In an embodiment, the body 504 is formed from metal, including extruded aluminum. A post adjacent the first end extends from the bottom wall into the interior of the cover for interacting with elements at each end of the drawer 602. The post may be secured to the cover by passing a threaded fastener from the exterior through a hole into a threaded opening in the post.

The drawer 602 has a body 604 with a bottom wall 606 extending between a first end wall 620 at a first end 610, and a second end wall 622 at a second end 612. The first end wall 620 forms an upwardly-open U-shaped notch 621 for receiving the front wall 832 of the first end wall cap 740. A curved first side wall 624 and an opposite curved second side wall 626 extend upward from the bottom wall 606 and extend between the first end 610 and second end 612. The bottom wall 606 and side walls 624, 626 form a generally concave bottom to the drawer 602. In an embodiment, the drawer 602 is sized to conform to the interior of the cover 502, with the first and second end walls 620, 622 conforming to the generally oval shaped ends of the cover 502 and the side walls 624, 626 conforming to side walls of the cover 502. The bottom wall 606 forms an elongated opening 608 extending between the first end 610 and second end 612 accommodating passage of the post therebetween. An element contacts the post when the drawer 602 is positioned in a closed position within the cover 502, and an element contacts the post when the drawer 602 is positioned in an open position with the drawer 602 extending from the cover 502. A divider 618 extends upward from the bottom wall 606 adjacent the opening 608 for aligning the tray within the drawer 602. Prongs extend from the first end wall 620 into the interior of the drawer 602 for retaining the end of the tray within the drawer 602. In an embodiment, the drawer 602 is manufactured from a rigid material, including plastic.

In an embodiment, the post includes magnetic material, and the elements include magnetic material. In an embodiment, the post includes magnetic material, and the elements include material that produces a magnetic field. In an embodiment, the post includes material that produces a magnetic field and the elements include magnetic material. In an embodiment, the magnetic material is ferromagnetic material.

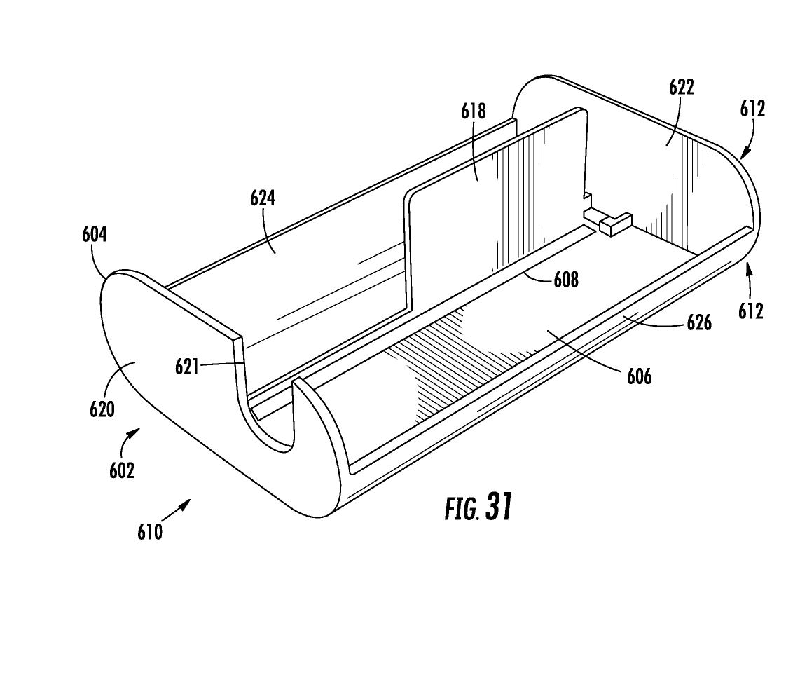

Referring to FIG. 31, an embodiment of the case 700 includes a tray 702 with various depressions for vaporizer components and accessories. The tray 702 includes a body 704 having a length extending between a first end 706 and a second end 708, and a width extending between a first side 716 and a second side 718. The top face 710 of the body 704 forms a first depression 722 for a container 764, a second depression 728 for a dab tool 786, a third depression 736 for a vaporizer pen, and a fourth depression 750 for a connecting cord or a vaporizer pen charging apparatus. The first depression 722 is at the first end 706 adjacent the first side 716 and includes opposing side walls 724a, b, and an end wall 726 opposite a second end wall 727 at the first end 706. The third depression 736 extends between the first end 706 and the second end 708 adjacent the second side 718 forming a removable first end wall cap 740 opposite a second end wall 742 connected by opposing side walls 738a, b. The first end wall cap 740 connects to the end of the vaporizer pen sealing the end and preventing odors from escaping the pen when the pen is in the case 700. The first end wall cap 740 mates with the third depression 736 and the first end wall 620 allowing the pen to be inserted and removed from the case 700 by inserting and removing the first end wall cap 740.

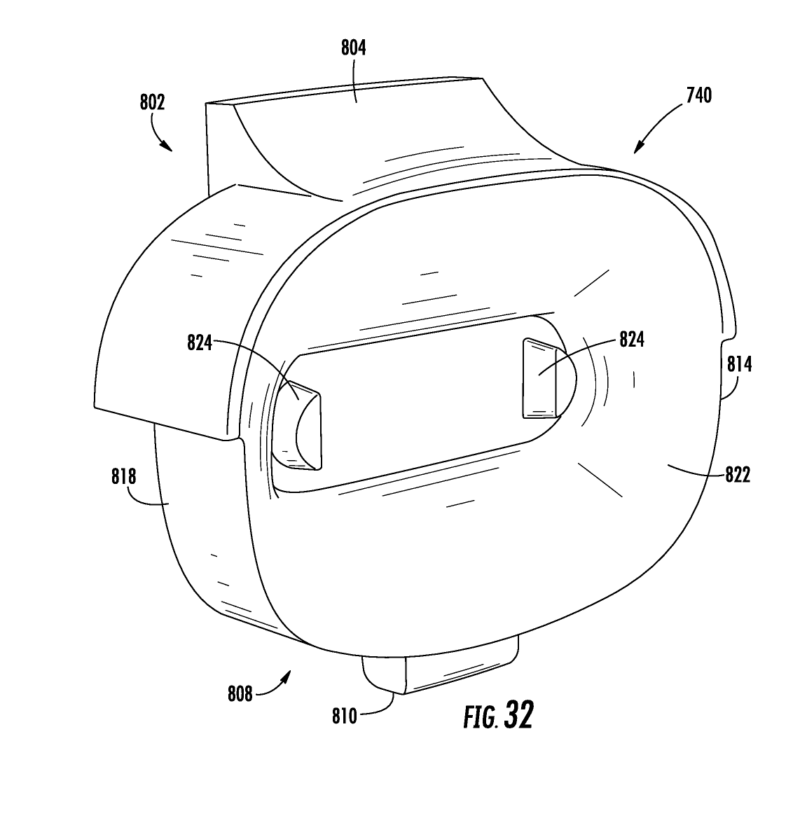

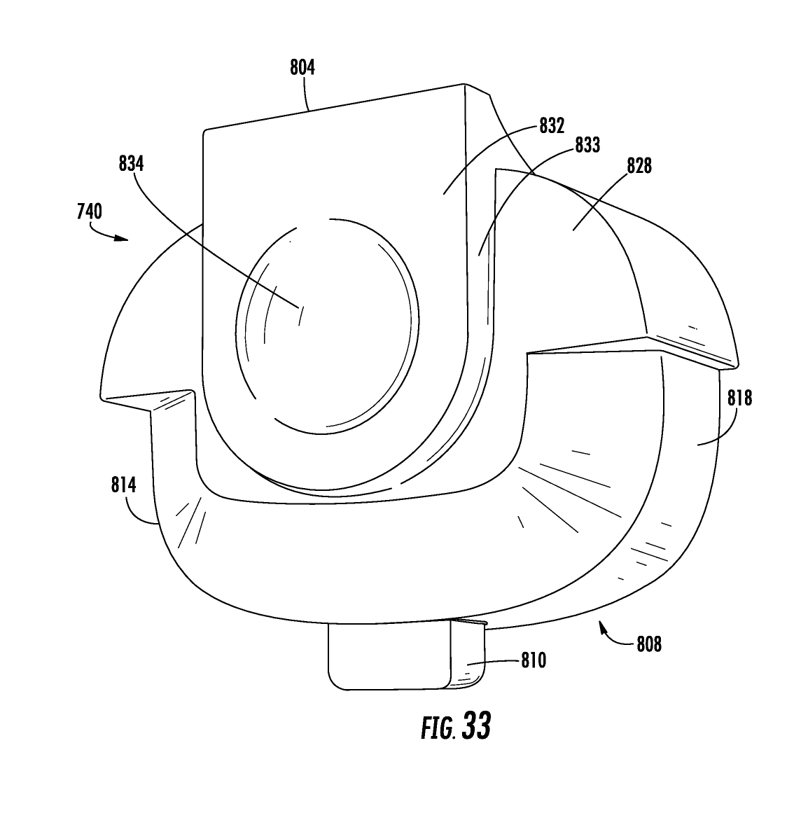

Referring to FIGS. 32-33, the cap 740 has a body forming a dish-shaped rear face 822 bound by an upward-extending upper wall 804 at a top end 802 and tab 810 depending from a bottom end 808. The left end 814 and opposite right end 816 form notches for receiving the upper edges of the sidewalls 738a, b. The front face 828 is opposite the rear face 822 and forms a front wall 832 with a U-shaped outer edge 833 conforming to the U-shaped notch 621.

In use, the rear face 622 is attached to the end of the pen, and the prongs 824 fit in holes in the end of the pen holding the cap 740 in place. The opposite end of the pen is inserted into the notch formed by the second end wall 742 and the front wall 832 is aligned with the U-shaped notch 621. The tab 810 is inserted into the tab opening 741 in the third depression 736. A depression 834 in the front wall 832 receives a finger of the user when inserting and removing the pen from the tray 702.

The second end wall 742 provides a notch for retaining the tip of the pen. A first retention member 744 and opposing second retention member 746 extend upward and inward from the top face 710 over the third depression 736 to partially circumscribe and retain the pen in the depression 736. The second depression 728 is between the fourth depression 750 and first side 716 adjacent the second end 708. The second depression 728 has a first side wall 730 and opposing second side wall 732 with an inner protrusion extending inward forming a channel for retaining the dab tool 786. The fourth depression 750 is adjacent the third depression 736 above the first depression 722. The fourth depression 750 extends between end wall 726 and the second end 708 forming a first end wall and an opposite second end wall 756 connected by opposing side walls 752a, b. The first end wall provides room at the base of the charger allowing removal of the charger by a finger. A gap 720 extending through the body 704 between the third depression 736 and fourth depression 750 is dimensioned to receive the divider 618 to position the tray 702 in the drawer 602.

In an embodiment, the tray 702 and first end wall cap 740 are manufactured from a flexible material, including molded silicone.

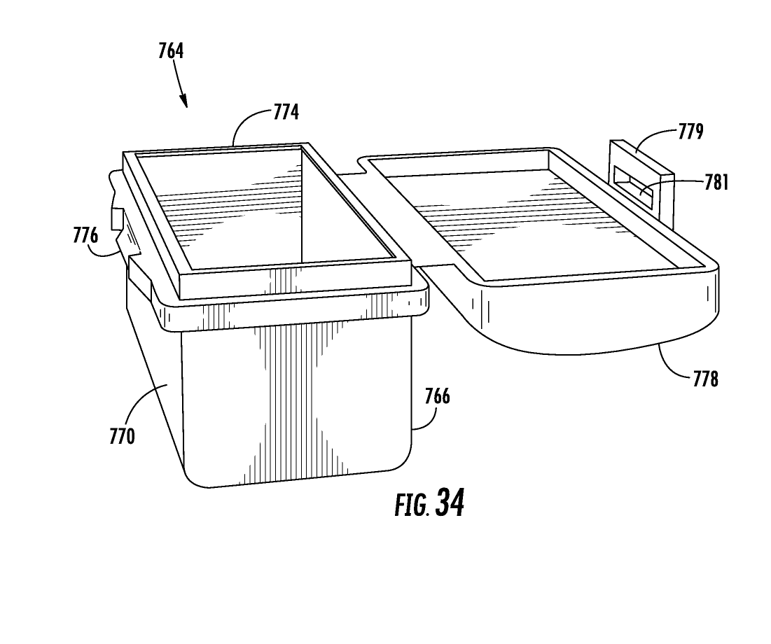

In an embodiment, the tray 702 includes a removable container 764 (FIG. 34) for storing the wax or liquid concentrate used with the pen. The container 764 includes a lid 778 that seals to a body 766. The body 766 forms an upwardly open container defined by side walls 770 extending upward from a bottom wall to a top edge 774. The lid 778 is joined to the body 766 by a hinge 780 and joins with the body 766 to seal the container 764. The lid 778 is secured to the body 766 by engaging a notch 781 in a tab 779 on the lid 778 opposite the hinge 780 with a protrusion 776 on the body 766 disposed opposite the hinge 780. The container 764 fits in the first depression 722. In an embodiment, the container 764 is manufactured from a flexible material, including molded silicone.

In an embodiment, the tray 702 includes a removable tool 786 or applicator device for removing liquid concentrate from the container 764 and applying it to the reservoir feeding the heating element of the pen, and for removing the accumulation of residue from the pen. The tool 786 is manufactured from plastic or metal, including stainless steel.

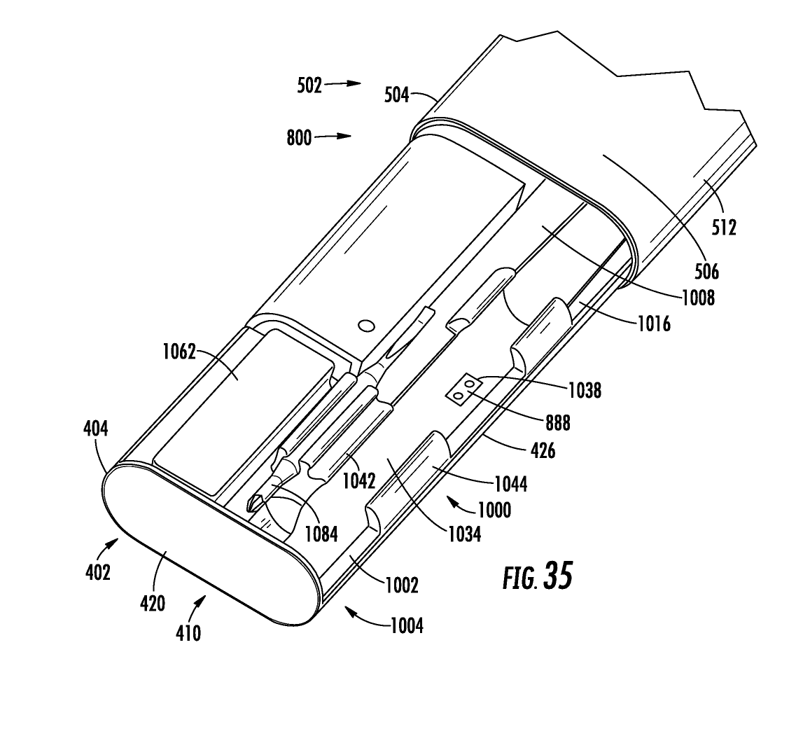

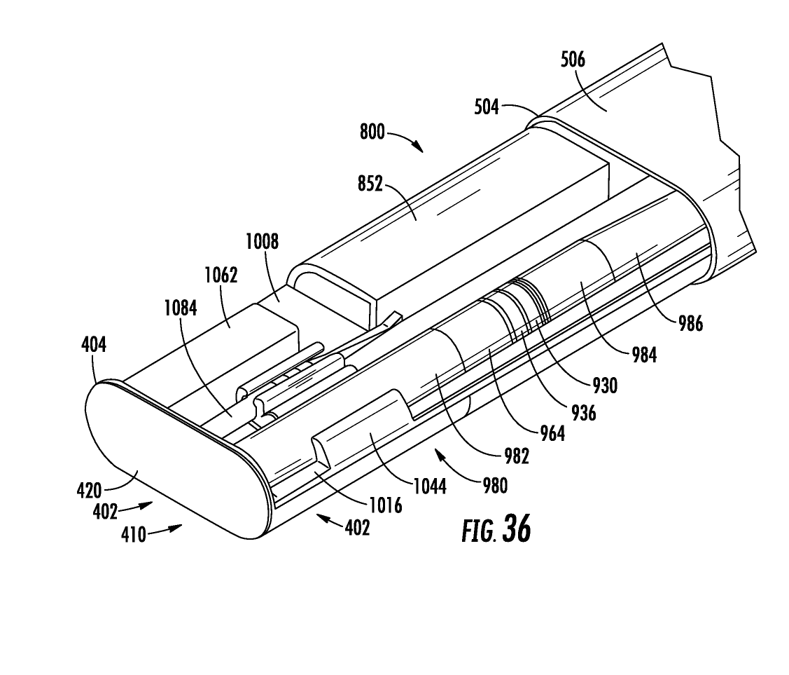

Referring to the drawings, a case 700 with a tray for organizing and protecting the components of a vaporizer pen is shown and described. Referring to FIGS. 35-36, the case 800 is shown in an open position and has a drawer 402 slidably moveable within a cover 502. The cover 502 has a body 504 forming a generally rectangular tubular cylinder extending between an open generally oval shaped first end 510 and an opposing generally oval shaped second end. The body 504 has a top wall 506 opposite a bottom wall connected by a first side wall and an opposite second side wall 512. In an embodiment, the body 504 is formed from metal, including extruded aluminum. A post adjacent the first end extends from the bottom wall into the interior of the cover for interacting with elements at each end of the drawer 402. The post may be secured to the cover by passing a threaded fastener from the exterior through a hole into a threaded opening in the post.

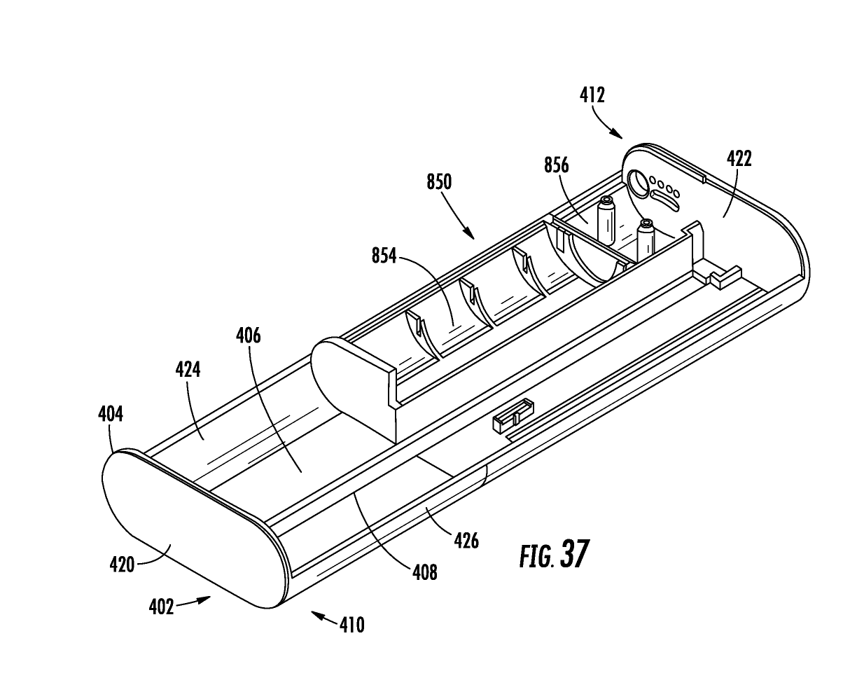

Referring to FIG. 37, the drawer 402 has a body 404 with a bottom wall 406 extending between a first end wall 420 at a first end 410, and an opposite second end wall 422 at a second end 412. A curved first side wall 424 and an opposite curved second side wall 426 extend upward from the bottom wall and extend between the first end 410 and second end 412. The bottom wall 406 and side walls 424, 426 form a generally concave bottom to the drawer 402. In an embodiment, the drawer 402 is sized to conform to the interior of the cover 502, with the first end wall 420 and second end wall 422 conforming to the generally oval shaped ends of the cover 502 and the side walls 424, 426 conforming to side walls of the cover 502. The bottom wall 406 of the drawer 402 forms an elongated opening 408 extending between the first end 410 and second end 412 accommodating passage of the post therebetween. An element contacts the post when the drawer 402 is positioned in a closed position within the cover 502, and an element contacts the post when the drawer 402 is positioned in an open position with the drawer 402 extending from the cover 502. A divider extends upward from the bottom wall adjacent the opening for aligning the tray within the drawer 402. In an embodiment, the drawer 402 is manufactured from a rigid material, including plastic.

In an embodiment, the post includes magnetic material, and the elements include magnetic material. In an embodiment, the post includes magnetic material, and the elements include material that produces a magnetic field. In an embodiment, the post includes material that produces a magnetic field and the elements include magnetic material. In an embodiment, the magnetic material is ferromagnetic material.

Referring to FIGS. 35-36, an embodiment of the case 800 includes a tray 1000 with various depressions for vaporizer components and accessories, a battery assembly 876 for use with a coupler assembly 900 for charging a vaporizer pen 980 when it is positioned therein. The tray 1000 includes a body 1002 having a length extending between a first end 1004 and an opposite second end, and a width extending between a first side and a second side 1016. The top face 1008 of the body 1002 forms a first depression for a container 1062, a second depression for a dab tool 1084, a third depression 1034 for a vaporizer pen, and a fourth depression for a vaporizer pen charging apparatus. The first depression is at the first end 1004 adjacent the first side and includes opposing side walls and an end wall opposite a second end wall at the first end 1004. The third depression 1034 extends between the first end 1004 and the second end adjacent the second side 1016.

The second end wall provides a notch for retaining the tip of the pen. A first retention member 1042 and opposing second retention member 1044 extend upward and inward from the top face 1008 over the third depression 1034 to partially circumscribe and retain the pen in the depression 1034. The second depression is between the fourth depression and first side adjacent the second end. The second depression has a first side wall and opposing second side wall with an inner protrusion extending inward forming a channel for retaining the dab tool 1084.

In an embodiment, the tray 1000 is manufactured from a flexible material, including molded silicone.

In an embodiment, the tray 1000 includes a removable container 1062 for storing the wax or liquid concentrate used with the pen.

In an embodiment, the tray 1000 includes a removable tool 1084 or applicator device for removing liquid concentrate from the container 1062 and applying it to the reservoir feeding the heating element of the pen, and for removing the accumulation of residue from the pen. The tool 1084 is manufactured from plastic or metal, including stainless steel.

Referring to FIG. 37, the drawer 402 is shown with the tray 1000 and battery cavity cover 852 removed. A battery cavity 850 is formed from the drawer 402, and is configured to receive a battery subassembly 876. The battery cavity 850 forms a battery bay 854, and a circuitry bay 856. The back end of the circuitry bay 856 includes the second end wall 422 with openings for LED indicator lights for displaying charging status and battery capacity, a power button, and the connector 886, all connected to the circuitry 884. The battery subassembly 876 includes a battery 878, such as a type 18650 rechargeable battery disposed between a positive contact 880 and a negative contact 882, charging and discharging circuitry 884, a connector 886 for connecting to an external power source, and a contact 888 accessible from the third depression 1034 for connection to a coupler assembly 900 attached to a vaporizer pen power supply. The battery 878 and positive and negative contacts 880, 882 reside in the battery bay 854. The circuitry 884 resides in the circuitry bay 856. The contact 888 includes a positive and negative terminals that protrude therefrom and are mounted to the drawer 402 adjacent the battery bay 854. The contact 888 is located in the drawer 402 to align with a contact opening in the tray 1000.

The components of a vaporizer pen generally include a battery connected to one end of an atomizer, and a mouthpiece connected to the free end of the atomizer. Referring to FIG. 36, a vaporizer pen 980 is shown in the third depression 1034 of the tray, with a coupler assembly 900 disposed between a rechargeable battery 982 and an atomizer 984. The third depression 1034 is dimensioned to accommodate the coupler assembly 900 connected to the battery 982 and the atomizer 984, as well as the mouthpiece 986 connected to the other end of the atomizer 984.

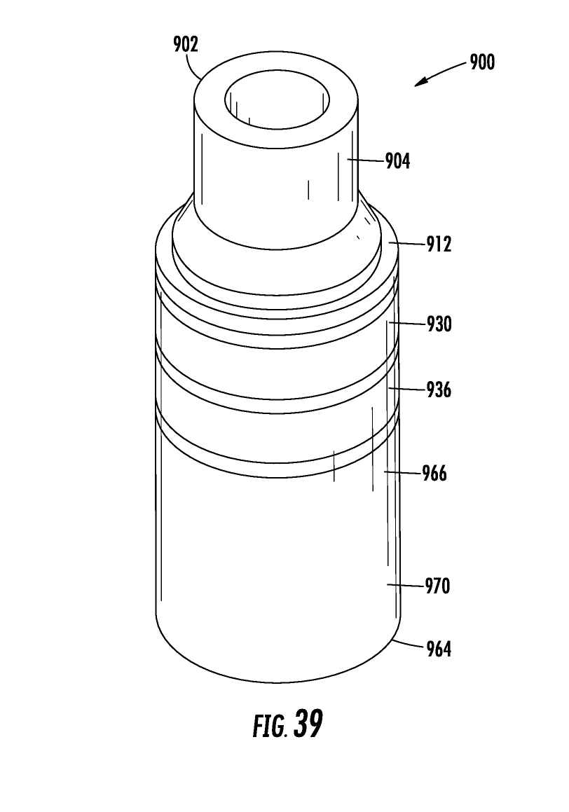

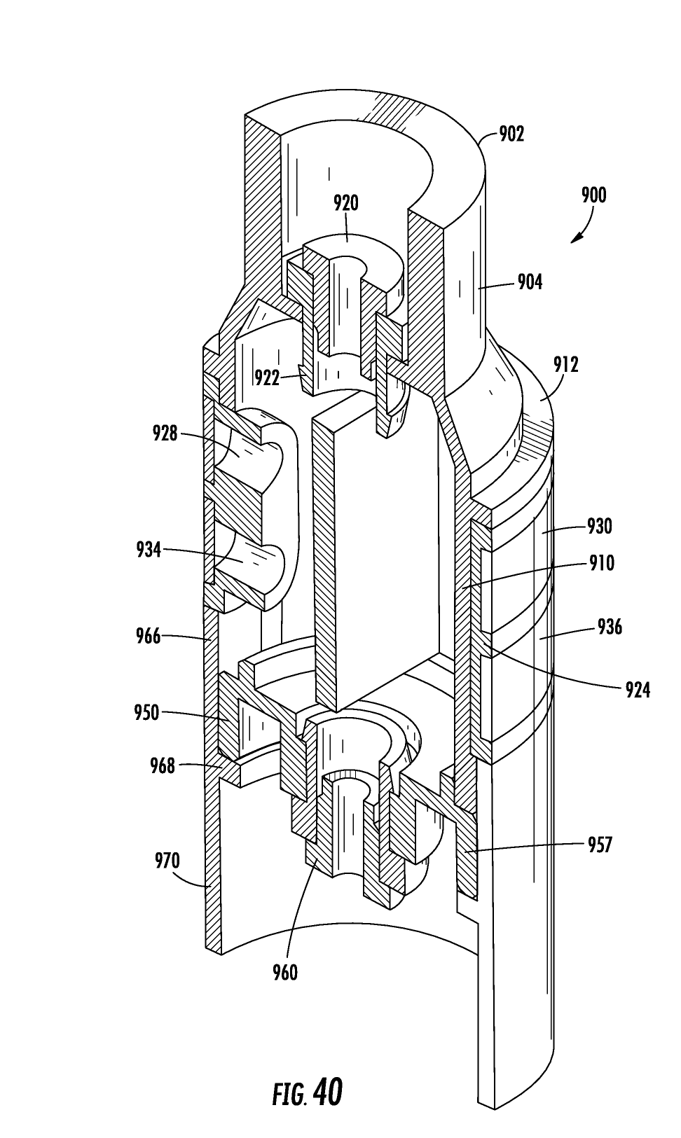

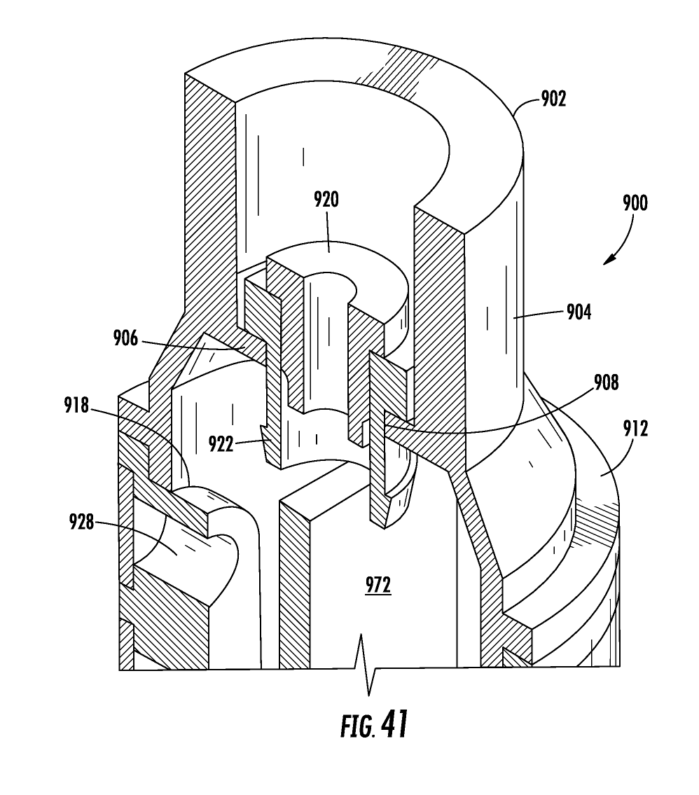

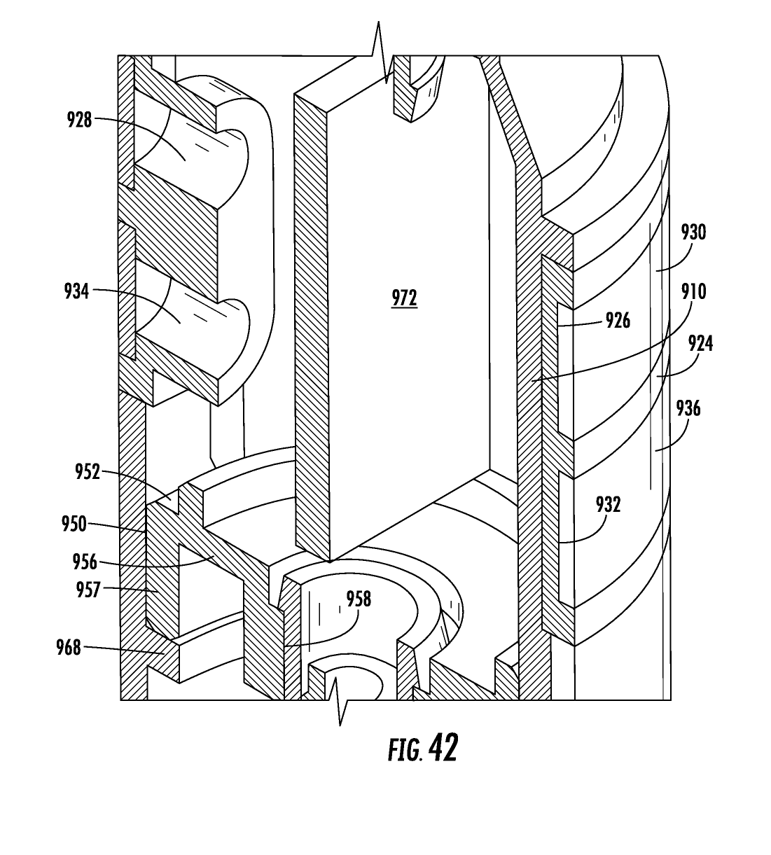

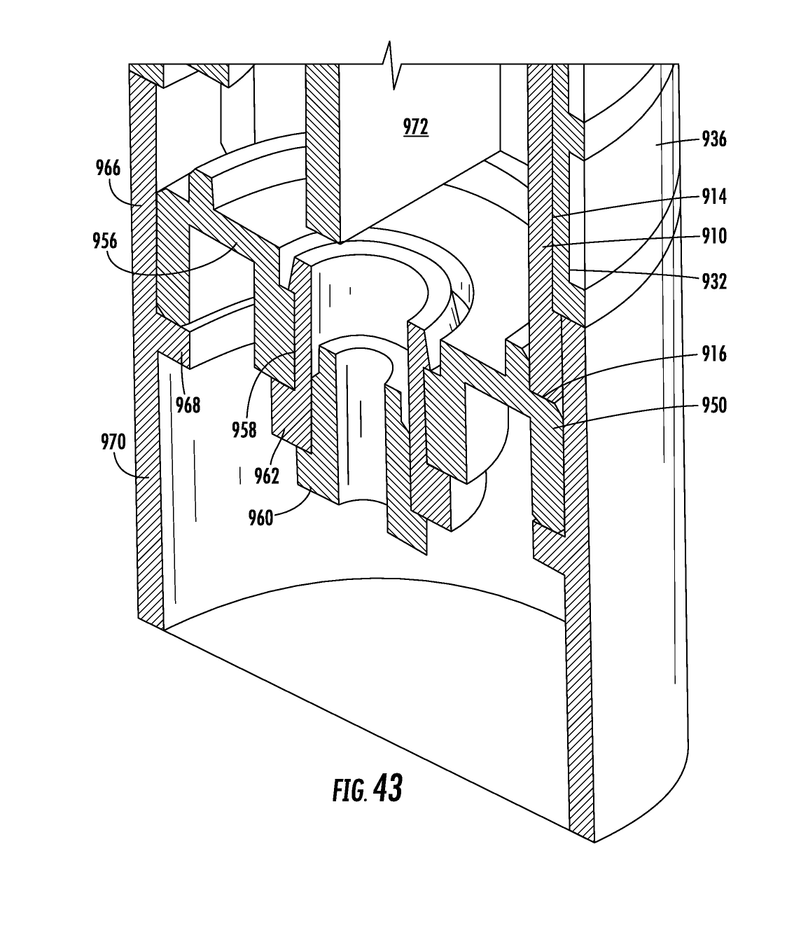

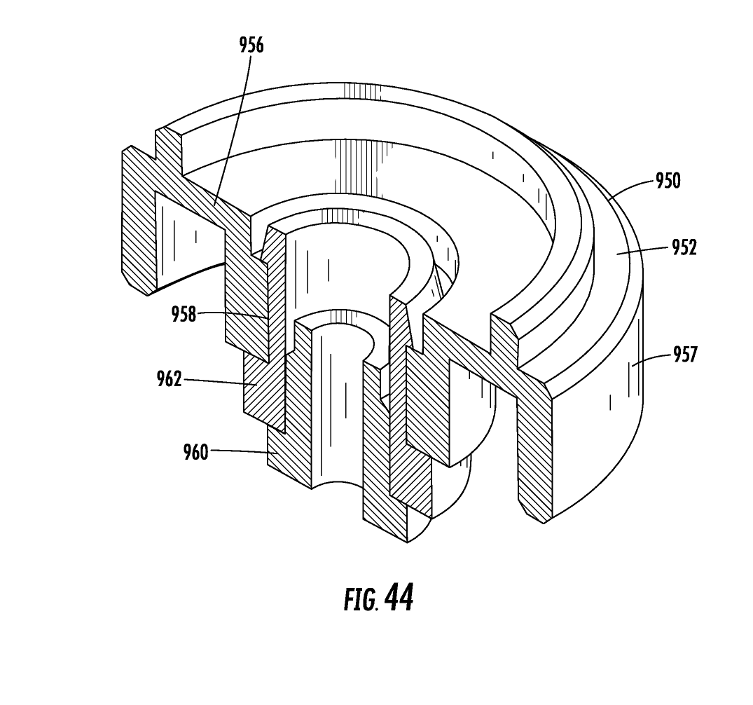

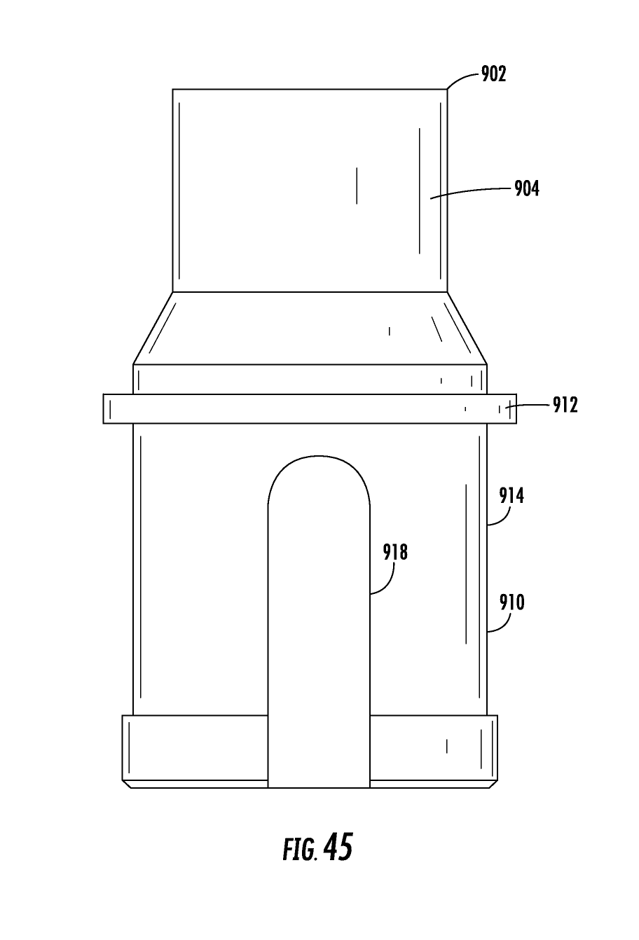

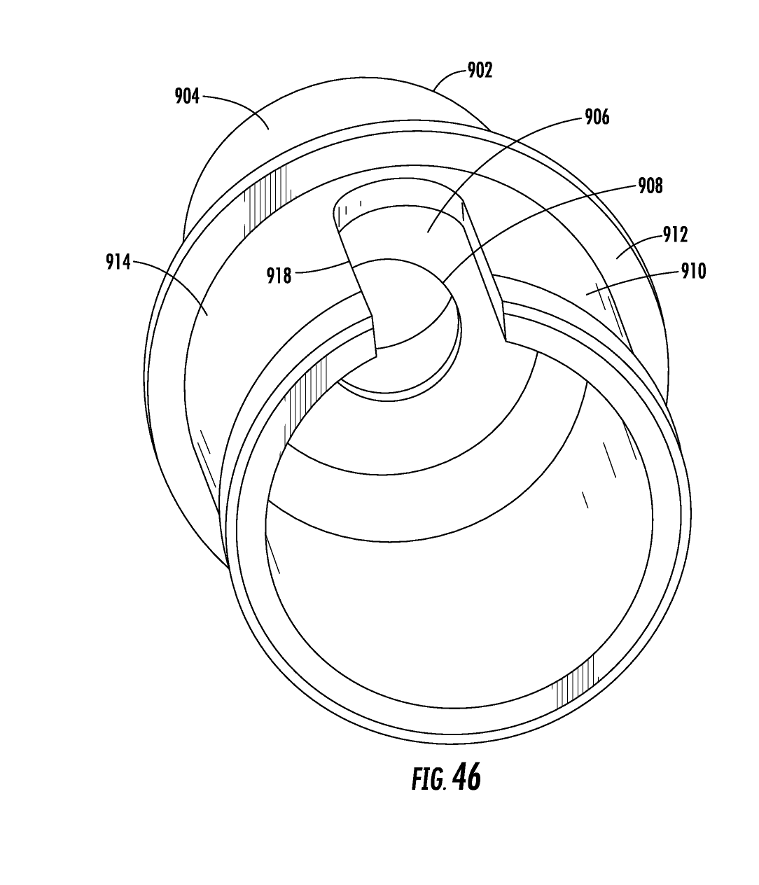

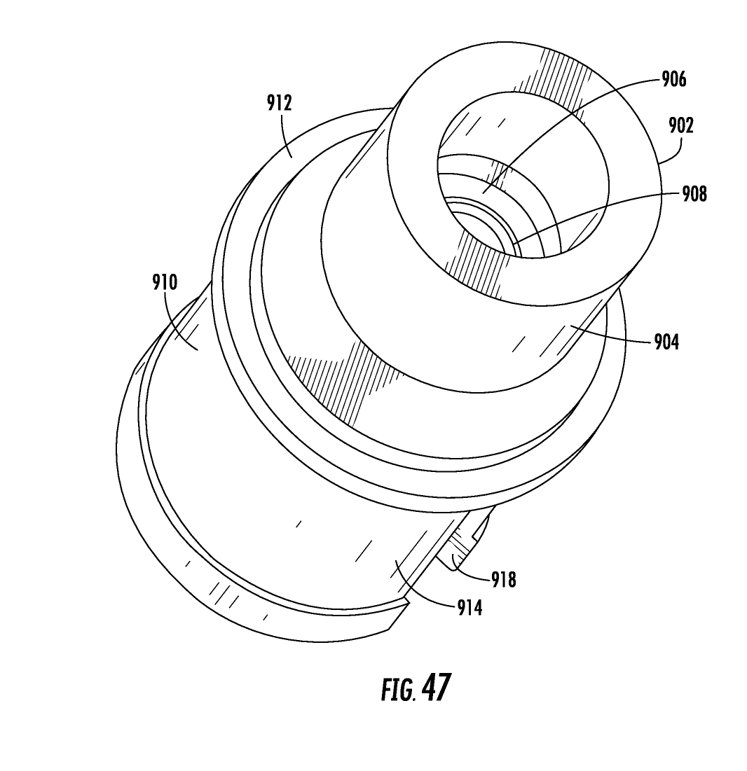

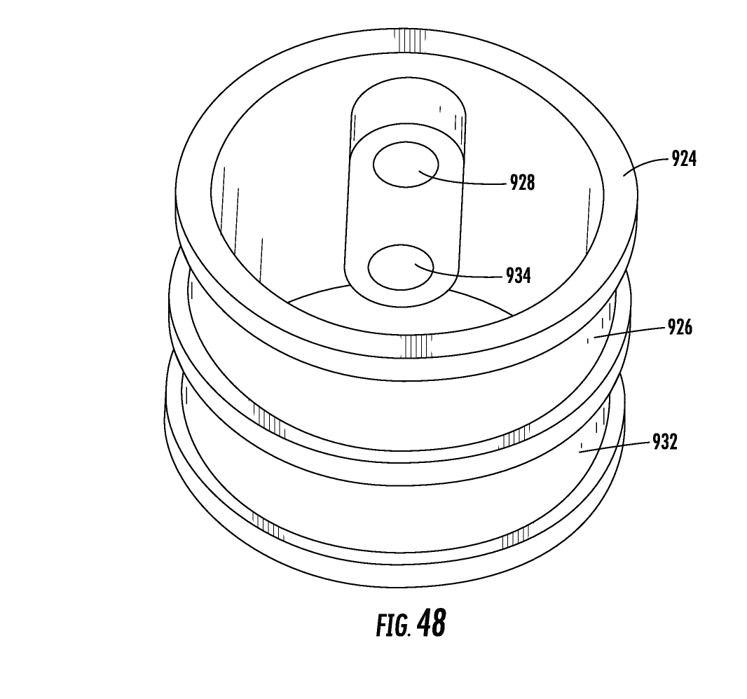

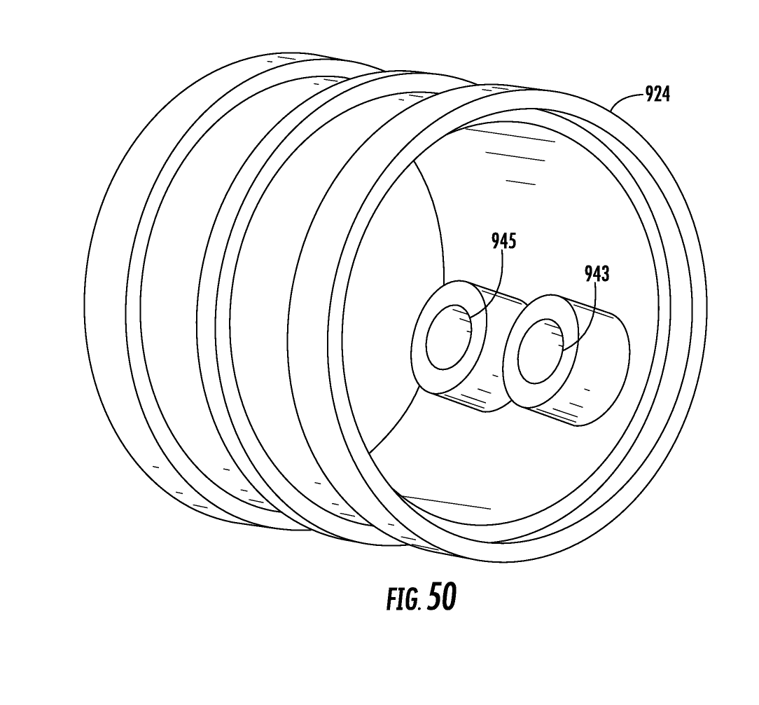

Referring to FIGS. 39-50, components of the coupler assembly 900 are shown and described. Coupler assembly 900 is generally tubular and includes a main body 902 joined to an outer shell 964. The main body 902 presents a first contact ring 930 and adjacent second contact ring 936 for engagement with the positive and negative terminals of the contact 888. Main body 902 has a tubular upper member 904 forming a central wall 906 with a port 908 for receiving upper central connector insulator 922. The upper central connector insulator 922 includes a central opening for receiving an upper central connector 920. The main body 902 extends below the central wall 906 forming a flange 912 and a lower member 910. The exterior of the lower member 910 forms an annular seat 914 for receiving a generally tubular contact insulator 924, and an opening 918 for first and second passages 928, 934. The contact insulator 924 presents a first groove 926 for the first contact ring 930, and a second groove 932 for the second contact ring 936. The contact insulator 924 insulates the contact rings 930, 936 from one another, and the contact rings from the main body 902. The contact insulator 924 form a first passage 928 communicating with the first groove 926, and a second passage 934 communicating with the second groove 932 allowing leads to extend from the contact rings to the charging control circuitry 972. The control circuitry 972 moves the charging location from the top of the vaporizer battery 982 to the coupler assembly 900. The circuitry 972 has a relay that switches in order to move the electrical power into two directions. The charging location on the coupler assembly 900 is created by a connection of the first contact ring 930 with circuitry 972, and the second contact ring 936 with the circuitry 972. In order to charge the battery 982, there is a connection from the circuitry 972 to the lower connection 960 (operating, for example, as the positive contact), and the circuitry 972 to the lower body 970 (operating, for example, as a negative contact). In order to move electrical power from the rechargeable battery 982 to the atomizer 984, there is a connection from the circuitry 972 to the upper connector 920 (operating, for example, as a positive contact), and the circuitry 972 to the upper member 904 (operating, for example, as a negative contact). The outer shell 964 is generally tubular and extends from an upper body 966 to a lower body 970. The interior of the outer shell 964 forms a flange 968 for retaining a bottom connector 950. The bottom end 916 of the main body 902 is received by the interior of the upper body 966 of the outer shell 964. The bottom connector 950 is held against the flange 968 within the interior of the outer shell 964 by the bottom end 916 of the main body 902. The bottom connector 950 includes a central wall 956 forming an upper rim 952, and a depending lower wall 957 with the bottom of the wall 957 resting on the flange 968. A central port 958 within the central wall 956 receives a tubular lower central connector insulator 962. The lower central connector insulator 962 includes a central opening for receiving a lower central connector 960.

In use, the coupler assembly is connected to the rechargeable battery 982 by connecting the terminal end of the battery 982 with the outer shell 964. The upper member 904 is connected to the base of the atomizer. The vaporize pen 980 with the coupler assembly 900 disposed between the rechargeable battery 982 and atomizer 984 is positioned in the third depression 1034 whereby the first contact ring 930 and second contact ring 936 are in electrical contact with the posts of contact 888. When the contact 888 is engaged, the battery 982 can be charged from the battery 878 or by a power supply connected to connector 886. When the vaporizer pen 980, couple assembly 900, and battery 982 are removed from the tray 1000 the circuitry 972 will permit the electricity from the battery 982 flow to the atomizer 984.

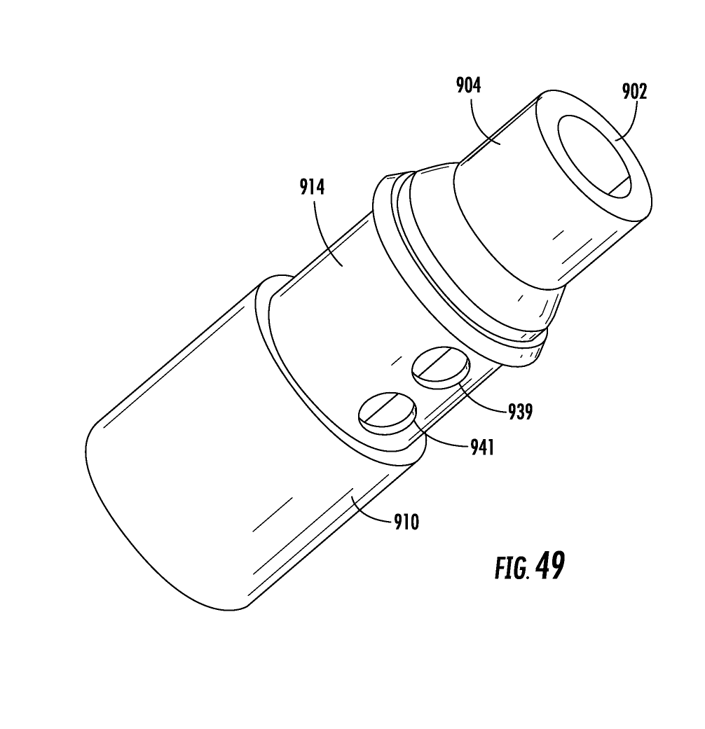

Referring to FIG. 49, an alternative embodiment main body 902 is shown with individual first opening 939, and second openings 941 for accommodating individual first passage 943, and second passage 945 of an alternative embodiment contact insulator 924.

Although the invention has been disclosed with reference to various particular embodiments, it is understood that equivalents may be employed and substitutions made herein without departing from the scope of the invention as recited in the claims.

Having thus described the disclosed subject matter, what is claimed is:

1. An apparatus, comprising:
a cover, comprising:
a body extending between a first end and a second end defining an interior bound by a top wall, an opposing bottom wall, a first side wall, and an opposing second side wall;
wherein the first end forms a first opening and the second end forms a second opening; and
a post disposed at the interior bottom wall adjacent the first end, wherein the post includes magnetic material;
a drawer received within the cover, comprising:
a bottom wall extending between a first end and a second end;
a first end wall at the first end and an opposing second end wall at the second end;
a first side wall and an opposing second side wall extending between the first end wall and second end wall;
an elongated opening formed by the bottom wall extending between the first end and the second end;
a first element disposed at the first end of the elongated opening and a second element disposed at the second end of the elongated opening;
wherein the first element and second element include magnetic material attracted to the post; and
wherein the post travels within the elongated opening between the first and second elements.

2. The apparatus of claim 1, wherein:
the first element is a first magnet; and
the second element is a second magnet.

3. The apparatus of claim 1, wherein the post is a magnet.

4. The apparatus of claim 1, further comprising a divider extending upward from the drawer bottom wall adjacent the drawer elongated opening.

5. The apparatus of claim 1, wherein the drawer first and second side walls conform to the cover first and second side walls.

6. The apparatus of claim 1, wherein the drawer first end wall conforms to the body first opening, and the drawer second end wall conforms to the body second opening.

7. The apparatus of claim 1, wherein:
the post is in contact with the first element when the drawer is in a closed configuration whereby the drawer bottom wall is within the cover; and
the post is in contact with the second element when the drawer is in an open configuration whereby the drawer second end wall is within the cover.

8. An apparatus, comprising:
a cover, comprising:
a body extending between a first end and a second end defining an interior bound by a top wall, an opposing bottom wall, a first side wall, and an opposing second side wall;
wherein the first end forms a first opening and the second end forms a second opening; and
a post disposed at the interior bottom wall adjacent the first end, wherein the post includes magnetic material;
a drawer received within the cover, comprising:
a bottom wall extending between a first end and a second end;
a first end wall at the first end and an opposing second end wall at the second end;
a first side wall and an opposing second side wall extending between the first end wall and second end wall;
an elongated opening formed by the bottom wall extending between the first end and the second end;
a first element disposed at the first end of the elongated opening and a second element disposed at the second end of the elongated opening;
wherein the first element and second element include magnetic material attracted to the post; and
wherein the post travels within the elongated opening between the first and second elements; and
a tray, comprising:
a body received in the drawer, the body extending between a first end and a second end, the body forming:
a top face with a second depression between a first depression and a third depression, wherein:
(a) the third depression extends between the body first end and body second end forming opposing first and second side walls, wherein:
(i) the body forms a first retention member extending upward from the top face adjacent the third depression first side wall and extending upward and inward from the top face over the third depression;
(ii) the body forms a second retention member extending upward from the top face adjacent the third depression second side wall and extending upward and inward from the top face over the third depression; and
a bottom forming a channel extending between the first end and the second end allowing passage of the post.

9. The apparatus of claim 8, further comprising a prong extending from the drawer first end wall retaining the tray in the drawer.

10. The apparatus of 8, further comprising:
a divider extending upward from the drawer bottom wall; and
a gap in the tray body receiving the divider.

11. The apparatus of 8, wherein the third depression first and second side walls taper inward as the walls transition from a point about the midpoint between the body first and second ends toward the body second end.

12. The apparatus of 8, further comprising a container received within the first depression, the container comprising:
a body forming an interior defined by side walls extending upward from a bottom wall, wherein the side walls form a groove at the interior;
a removable lid sealing the body, the lid comprising:
an upper portion; and
a bottom wall depending from the upper portion, the bottom wall forming a lip engaging the body groove.

13. The apparatus of 8, further comprising an applicator device retained by the second depression.

14. The apparatus of 8, further comprising:
a fourth depression disposed adjacent the third depression, the fourth depression extending between the body first end and body second end forming opposing first and second side walls, wherein:
the body forms a first retention member extending upward from the top face adjacent the fourth depression first side wall and extending upward and inward from the top face over the fourth depression;
the body forms a second retention member extending upward from the top face adjacent the fourth depression second side wall and extending upward and inward from the top face over the third depression.

15. The apparatus of 8, further comprising:
a battery subassembly, comprising:
a battery;
a contact operably connected to the battery; and
wherein the contact is accessible at the third depression for connection to a vaporizer pen power supply.

16. The apparatus of 8, further comprising a connector operably connected to the battery for charging the battery.

17. An apparatus, comprising:
a cover, comprising:
a body extending between a first end and a second end defining an interior bound by a top wall, an opposing bottom wall, a first side wall, and an opposing second side wall;
wherein the first end forms a first opening and the second end forms a second opening; and
a post disposed at the interior bottom wall adjacent the first end, wherein the post includes magnetic material;
a drawer received within the cover, comprising:
a bottom wall extending between a first end and a second end;
a first end wall at the first end and an opposing second end wall at the second end;
a first side wall and an opposing second side wall extending between the first end wall and second end wall;
an elongated opening formed by the bottom wall extending between the first end and the second end;
a first element disposed at the first end of the elongated opening and a second element disposed at the second end of the elongated opening;
wherein the first element and second element include magnetic material attracted to the post; and
wherein the post travels within the elongated opening between the first and second elements;
a tray, comprising:
an article assembly comprising a flexible body received in the drawer, the body extending between a first end and a second end forming:
a top face with a second depression between a first depression and a third depression, wherein:
(a) the third depression extends between the body first end and body second end forming opposing first and second side walls, wherein:
(i) the body forms a first retention member extending upward from the top face adjacent the third depression first side wall and extending upward and inward from the top face over the third depression;
(ii) the body forms a second retention member opposite extending upward from the top face adjacent the third depression second side wall and extending upward and inward from the top face over the third depression; and
a bottom forming a channel extending between the first end and the second end allowing passage of the post; and
a battery subassembly, comprising:
a battery compartment adapted to receive a battery;
a contact operably connected to the battery; and
wherein the contact is accessible at the third depression for connection to a vaporizer pen power supply.

18. The apparatus of claim 17, wherein:
the first element is a first magnet; and
the second element is a second magnet.

19. The apparatus of claim 17, wherein the post is a magnet.

20. The apparatus of claim 17, wherein:
the post is in contact with the first element when the drawer is in a closed configuration whereby the drawer bottom wall is within the cover; and
the post is in contact with the second element when the drawer is in an open configuration whereby the drawer second end wall is within the cover.

21. The apparatus of claim 17, further comprising a prong extending from the drawer first end wall retaining the tray in the drawer.

22. An apparatus, comprising:
a cover, comprising:
a body extending between a first end and a second end defining an interior bound by a top wall, an opposing bottom wall, a first side wall, and an opposing second side wall;
wherein the first end forms a first opening and the second end forms a second opening; and
a post disposed at the interior bottom wall adjacent the first end, wherein the post includes magnetic material;
a drawer received within the cover, comprising:
a bottom wall extending between a first end and a second end;
a first end wall at the first end and an opposing second end wall at the second end;
a first side wall and an opposing second side wall extending between the first end wall and second end wall;
an elongated opening formed by the bottom wall extending between the first end and the second end;
a first element disposed at the first end of the elongated opening and a second element disposed at the second end of the elongated opening;
wherein the first element and second element include magnetic material attracted to the post; and
wherein the post travels within the elongated opening between the first and second elements;
a tray, comprising:
an article assembly comprising a flexible body received in the drawer, the body extending between a first end and a second end forming:
a top face with a second depression between a first depression and a third depression, wherein:
(a) the third depression extends between the body first end and body second end forming opposing first and second side walls, wherein:
(i) the body forms a first retention member extending upward from the top face adjacent the third depression first side wall and extending upward and inward from the top face over the third depression;
(ii) the body forms a second retention member extending upward from the top face adjacent the third depression second side wall extending upward and inward from the top face over the third depression;
(iii) the body forms a contact opening; and
a bottom forming a channel extending between the first end and the second end allowing passage of the post; and
a battery assembly, comprising:
a battery connected to a contact; and
wherein the contact is at the contact opening;
a coupler, comprising:
a main body joined to an outer shell;
(a) the main body, comprising:
(i) a first contact ring adjacent a second contact ring for engagement with the contact;
(ii) an upper member forming a central wall;
(iii) an upper central connector insulator at the upper member central wall;
(iv) an upper central connector at the upper member central wall;
(v) wherein the main body extends below the central wall forming a flange and a lower member;
(vi) wherein the lower member forms an annular seat for receiving a generally tubular contact insulator, and forms an opening for first and second passages;
(vii) wherein the contact insulator forms a first groove for the first contact ring, and a second groove for the second contact ring; and
(viii) wherein the contact insulator forms a first passage communicating with the first groove, and a second passage communicating with the second groove;
(b) the outer shell, comprising:
(i) an upper body;
(ii) a lower body;
(iii) a flange at an interior of the outer shell;
(c) a bottom connector, comprising:
(i) a central wall forming an upper rim, and a depending lower wall;
(ii) a lower central connector insulator at the central wall; and
(iii) a lower central connector at the central wall.

23. The apparatus of claim 22, wherein:
the first element is a first magnet; and
the second element is a second magnet.

24. The apparatus of claim 22, wherein the post is a magnet.

25. The apparatus of claim 22, wherein:
the post is in contact with the first element when the drawer is in a closed configuration whereby the drawer bottom wall is within the cover; and
the post is in contact with the second element when the drawer is in an open configuration whereby the drawer second end wall is within the cover.

26. The apparatus of claim 22, further comprising a prong extending from the drawer first end wall retaining the tray in the drawer.

27. The apparatus of claim 22, further comprising:
a vaporizer pen battery; and
wherein the coupler is operably connected to the vaporizer pen battery.

28. An apparatus, comprising:
a coupler comprising a main body joined to an outer shell;
(a) the main body, comprising:
(i) a first contact ring adjacent a second contact ring;
(ii) an upper member forming a central wall;
(iii) an upper central connector insulator at the upper member central wall;
(iv) an upper central connector at the upper member central wall;
(v) wherein the main body extends below the central wall forming a flange and a lower member;
(vi) wherein the lower member forms an annular seat for receiving a generally tubular contact insulator, and forms an opening for first and second passages;
(vii) wherein the contact insulator forms a first groove for the first contact ring, and a second groove for the second contact ring; and
(viii) wherein the contact insulator forms a first passage communicating with the first groove, and a second passage communicating with the second groove;
(b) the outer shell, comprising:
(i) an upper body;
(ii) a lower body;
(iii) a flange at an interior of the outer shell;
(c) a bottom connector, comprising:
(i) a central wall forming an upper rim, and a depending lower wall;
(ii) a lower central connector insulator at the central wall; and
(iii) a lower central connector at the central wall.

29. The apparatus of claim 28, further comprising:
a vaporizer pen battery; and
wherein the coupler is operably connected to the vaporizer pen battery.
